(19) United States
(12) Patent Application Publication
(10) Pub. No.: US 2026/0353215 A1
(43) Pub. Date: Nov. 5, 2026

(54) METHOD AND APPARATUS FOR USE IN MANAGING HANDOVER OF A RELAY USER EQUIPMENT

(71) Applicant: CANON KABUSHIKI KAISHA, Tokyo (JP)

(72) Inventors: Pascal LAGRANGE, La Chapelle des Fougeretz (FR); Romain GUIGNARD, Rennes (FR)

(21) Appl. No.: 19/115,458

(22) PCT Filed: Sep. 27, 2023
(86) PCT No.: PCT/EP2023/076729

§ 371 Date: Mar. 26, 2025

(30) Foreign Application Priority Data
Sep. 30, 2022 (GB) 2214338.2

(51) Int. Cl. H04W 36/00; H04W 36/08; H04W 36/36; H04W 88/04

(52) U.S. Cl. CPC H04W 36/033; H04W 36/0009; H04W 36/0033; H04W 36/008355; H04W 36/08; H04W 36/362; H04W 88/04

(57) ABSTRACT

A method for use in managing handover of a relay user equipment, UE, from a source base station to a target base station, the relay UE serving one or more remote UEs via one or more sidelink connections, is disclosed. The method at the source base station comprises sending, to the target base station, a handover request for the relay UE and sending, to the target base station, remote UE information associated with all or some of the one or more remote UEs served by the relay UE. The remote UE information may be sent as part of managing handover of the relay UE. In an example, the remote UE information is associated with the remote UEs which would remain connected to the relay UE after handover for the relay UE is completed. Methods at the target base station and relay UE and apparatus are also disclosed.

### CROSS-REFERENCE TO RELATED APPLICATIONS

The application is the National Phase application of PCT Application No. PCT/EP2023/076729, filed on Sep. 27, 2023 and titled “METHOD AND APPARATUS FOR USE IN MANAGING HANDOVER OF A RELAY USER EQUIPMENT”. This application claims the benefit under 35 U.S.C. § 119 (a)-(d) of United Kingdom Patent Application No. 2214338.2, filed on Sep. 30, 2022 and titled “METHOD AND APPARATUS FOR USE IN MANAGING HANDOVER OF A RELAY USER EQUIPMENT”. Each of the above cited patent applications are incorporated herein by reference in its entirety.

### FIELD OF THE INVENTION

The present invention generally relates to managing handover of a relay User Equipment, UE, in a sidelink relay-based network of a wireless communication system. More particularly, the present invention relates to managing the handover of a Relay UE and its served Remote UE(s) in a cellular Sidelink relay-based network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as WiFi.

In order to support new vehicle-to-anything (V2X) scenarios in the context of road safety services, 3GPP introduced NR sidelink (SL) communications, or PC5 communications, in 3GPP Release 16. The purpose of such technology was to provide support for broadcast, groupcast and unicast communications between any two User Equipments (UEs) in both out-of-coverage and in-network coverage scenarios.

Based on the NR sidelink technology, 3GPP introduced the sidelink-based relaying functionality as part of the 3GPP Release 17 framework, where a relay UE may provide User Plane (UP) and Control Plane (CP) data relaying between a set of served remote UEs and the network (UE-to-network, or U2N, relay) or between a source remote UE, or source UE, and a target remote UE, or target UE (UE-to-UE, or U2U relay).

The purpose of the Release 17 sidelink relaying functionality was to both extend sidelink/network coverage and improve power efficiency, while considering a wider range of applications and services, including V2X, Public Safety and commercial applications and services. Some of these new V2X scenarios require ultra-reliability and low latency (URLLC) performance, in order to meet high-speed and high-density constraints, while requiring some network coverage extension, which may be achieved through sidelink relaying.

This first version of the sidelink relaying functionality, as defined in the Release 17 specification, mainly aimed at supporting the UE-to-network (U2N) relay while setting the foundations for the UE-to-UE (U2U) relay, to be further studied in 3GPP Release 18.

Along with the support of the new Release 18 UE-to-UE (U2U) relay use cases, 3GPP is also considering further enhancements to the existing Release 17 Sidelink Relay specification, which aim at ensuring service continuity, by allowing flexible inter/intra-base station (for 5G NR the base station is referred to as a gNB) path switching, while improving reliability/robustness and throughput, with the support of multi-path with relay.

Ensuring service continuity in a 3GPP network based on sidelink relay raises the issue of managing the handover of a relay UE, along with the one or more remote UEs it is serving, from a source gNB to a target gNB. In this respect, based on measurement reports issued by a relay UE over its Uu radio link with a source base station, or source gNB, this source gNB may identify the need for initiating the handover (HO) of this relay UE to a target base station, or target gNB, or may identify the need for configuring a conditional handover (CHO) at this relay UE.

Upon reception of one or more measurement reports from the relay UE over its Uu radio link, the source gNB may conclude that the relay UE has better Uu connectivity with a target gNB and in response to such a conclusion, may further negotiate the handover of the relay UE with this target gNB, before requesting the relay UE to re-establish connectivity with the target gNB in case the negotiation is successful. This procedure is referred to as a legacy handover (HO) procedure.

Based on the measurement reports received from the relay UE, the source gNB may alternately decide to provision the conditional handover (CHO) of the relay UE. In this case, the source gNB may allow the relay UE to decide to perform handover provided that some specific conditions are met. Contrary to the legacy handover procedure, where the network is in charge of deciding whether the handover should be performed or not, the conditional handover (CHO) provides a more reactive process performed by the relay UE which may limit the occurrences of handover failures.

Both legacy and conditional handovers at the relay UE would imply the handover of all or part of the remote UEs that are served by the relay UE.

However, performing a full handover process for each remote UE, on a per-UE basis, may result in some significant latency for connection reestablishment from the source base station to the target base station, while also causing significant control traffic increase and message collisions, e.g. when the remote UEs perform the Random Access Channel, or RACH, procedure during connection reestablishment.

This is all the more undesirable considering such handover process may not be needed for all the remote UEs served by the relay UE performing a legacy handover (HO) or a Conditional Handover (CHO). Indeed, some remote UEs that have good direct connectivity with another base station or with one or more other UEs capable of performing sidelink relaying may wish to detach from the handed over relay UE and perform either relay reselection or connect directly to another base station.

Therefore, some new mechanisms are required to facilitate the handover of all or part of the remote UEs served by a relay UE that is to perform a handover (e.g. legacy or a conditional handover), whilst addressing the aforementioned issues.

### SUMMARY

In accordance with an aspect of the present invention, there is provided method for use in managing handover of a relay user equipment, UE, from a source base station to a target base station, the relay UE serving one or more remote UEs via one or more sidelink connections, the method at the source base station comprising:
sending, to the target base station, a handover request for the relay UE;
sending, to the target base station, remote UE information associated with all or some of the one or more remote UEs served by the relay UE,
wherein the remote UE information includes a list of multipath remote UEs information for indicating at least one of the number and identifiers of the one or more remote UEs also directly connected to the source base station.

The remote UE information associated with all or some of the one or more remote UEs served by the relay UE is sent as part of managing handover of the relay UE. The remote UE information may be associated with remote UEs which would remain connected to the relay UE after handover for the relay is completed.

By providing remote UE information for all or some of the remote UEs served by the relay UE to the target base station as part of managing handover of the relay UE (e.g. when negotiating handover of the relay UE between the source base station and target base station and so prior to when handover of the remote UEs is executed), the management of handover of the relay UE and remote UEs served by the relay UE to the target base station and/or execution of handover of the relay UE and remote UEs when the relay UE is handed over to the target base station is improved (e.g. the handover management can be faster and more efficient). For example, as part of handover management, the remote UE information can help the target base station determine whether the handover of the relay UE and/or all or some of the remote UEs can be accepted and so may allow the target base station to better evaluate the potential impact of the relay UE and the remote UEs served by the relay UE on the performance of the network cell managed by the target base station.

The source base station may receive, for example from the relay UE, remote UE handover information for indicating which remote UEs of the one or more remote UEs would remain connected to the relay UE after handover of the relay UE is completed.

The remote UE information may further include at least one of: sidelink remote UE handover information for indicating that the UE for which a handover has been requested is a remote UE; list of remote UEs information for indicating at least one of the number and the identifiers of the remote UEs which would remain connected to the relay UE after handover for the relay UE is completed; list of bounded remote UEs information for indicating at least one of the number and the identifiers of the one or more remote UEs having a certain relationship with the relay UE; remote UE context information including context information for at least one of the all or some of the one or more remote UEs; remote UE requirement information for indicating communication requirements for at least one of the all or some of the one or more remote UEs.

Where the remote UE information includes remote UE context information for the all or some of the remote UEs, by sharing context information for the remote UEs with the source base station, handover of the remote UEs from the source base station to the target base station can be faster and more efficient as the remote UEs would then not need to share this context information with the target base station when performing handover and connection reestablishment upon relay UE handover.

In an example, sending the handover request comprises sending the handover request for the relay UE in a handover request message, and sending remote UE information comprises sending remote UE information in the handover request message for the relay UE.

In another example, sending the handover request comprises sending the handover request for the relay UE in a handover request message, and sending remote UE information comprises sending first remote UE information in the handover request message for the relay UE and sending second remote UE information in at least one different message to the handover request message for the relay UE. The first remote UE information included in the handover request message for the relay UE may include remote UE quantity information for indicating a quantity of resource required at the target base station for the all or some of the one or more remote UEs served by the relay UE and the second remote UE information included in a different message to the handover request message for the relay UE includes remote UE context information including context information for at least one remote UE of the all or some of the one or more remote UEs.

In another example, sending the handover request comprises sending the handover request for the relay UE in a handover request message, and sending remote UE information comprises sending remote UE information in at least one different message to the handover request message for the relay UE. The at least one different message may be at least one handover request message for a remote UE.

Sending remote UE information may comprise sending first remote UE information in a first different message, such as a handover request message for one or more than one remote UEs and sending second remote UE information in a second different message.

In an example, handover status information indicating handover granted status for the relay UE and/or all or some of the one or more remote UEs served by the relay UE may be received by the source base station.

Sending remote UE information may comprise sending, as part of remote UE information, context information only for the remote UEs for which handover has been accepted. By sending context information only for the remote UEs accepted for handover instead of sending context information for each of the all or some of the one or more remote UEs, the amount of information transmitted is limited to what is needed which helps to minimise the resources (processing and signalling) used.

In accordance with another aspect of the present invention, there is provided a method, performed at the target base station, for use in managing handover of a relay user equipment, UE, from a source base station to a target base station, the relay UE serving one or more remote UEs via one or more sidelink connections. The method comprises: receiving, from the source base station, a handover request for the relay UE; receiving, from the source base station, remote UE information associated with all or some of the one or more remote UEs served by the relay UE, wherein the remote UE information includes a list of multipath remote UEs information for indicating at least one of the number and identifiers of the one or more remote UEs also directly connected to the source base station. In accordance with another aspect of the present invention, there is provided apparatus for a source base station for use in managing handover of a relay user equipment, UE, from the source base station to a target base station, the relay UE serving one or more remote UEs via one or more sidelink connections. The apparatus comprises: one or more processing units configured to: send, to the target base station, a handover request for the relay UE; send, to the target base station, remote UE information associated with all or some of the one or more remote UEs served by the relay UE, wherein the remote UE information includes a list of multipath remote UEs information for indicating at least one of the number and the identifiers of the one or more remote UEs also directly connected to the source base station.

In accordance with another aspect of the present invention, there is provided apparatus for a target base station for use in managing handover of a relay user equipment, UE, from the source base station to a target base station, the relay UE serving one or more remote UEs via one or more sidelink connections. The apparatus comprises: one or more processing units configured to: receive, from the source base station, a handover request for the relay UE; receive, from the source base station, remote UE information associated with all or some of the one or more remote UEs served by the relay UE, wherein the remote UE information includes a list of multipath remote UEs information for indicating at least one of the number and the identifiers of the one or more remote UEs also directly connected to the source base station.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIG. 2a is a schematic diagram illustrating user plane stacks of some protocol layers involved in Sidelink relay operations for UE-to-network (U2N) based relaying;

FIG. 2b is a schematic diagram illustrating user plane stacks of some protocol layers involved in Sidelink relay operations for UE-to-UE (U2U) based relaying;

FIG. 3, FIG. 4 and FIG. 5 are schematic and simplified diagrams illustrating some example message flows for managing relay UE legacy handover (HO) or relay UE conditional handover (CHO) according to embodiments of the invention;

FIG. 6 and FIG. 7 are flow diagrams of examples of operations at a source base station for managing relay UE legacy handover (HO) or relay UE conditional handover (CHO) according to some embodiments of the invention;

FIG. 8 and FIG. 9 are flow diagrams of examples of operations at a target base station for managing relay UE legacy handover (HO) or relay UE conditional handover (CHO) according to some embodiments of the invention;

FIG. 10 is a block schematic diagram of an example wireless communication device in accordance with embodiments of the present invention;

FIG. 11 is a flowchart of a method performed at the source base station in accordance with one or more embodiments of the present invention;

FIG. 12 is a flowchart of a method performed at the target base station in accordance with one or more embodiments of the present invention;

FIG. 13 is a flowchart of a method performed at the relay UE in accordance with one or more embodiments of the present invention.

### DETAILED DESCRIPTION

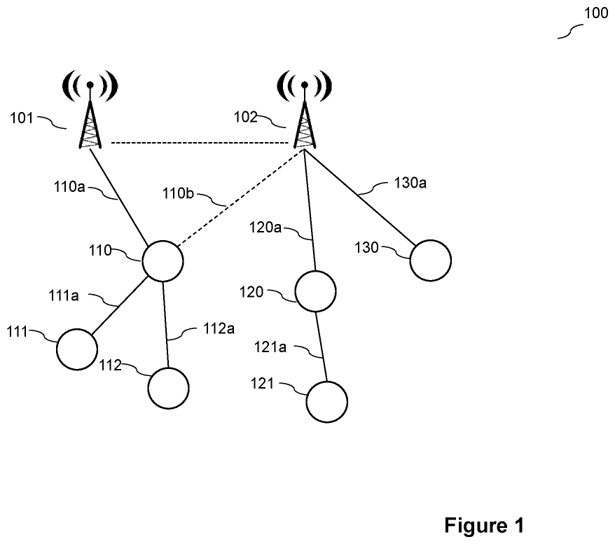

FIG. 1 represents an example of a wireless communication system 100 capable of supporting Sidelink Relay and shows a sidelink relay arrangement or system (or network) including a plurality of nodes including a relay User Equipment (UE) serving one or more remote User Equipment (UE).

For instance, in FIG. 1, UE node 110 is served by network node 101 and may operate as a relay UE node relaying data between one of the UE nodes 111, 112 (referred to as remote UE nodes) and the network node 101, hence performing UE-to-network (U2N) relay. In an example where the network node 101 is part of a cellular network, the relay UE 110 is served by a cell controlled by the network node 101.

UE node 120 is served by network node 102 and may also operate as a UE-to-network (U2N) relay UE node (for example, relaying data between the remote UE 121 and the network node 102).

UE node 130 is also served by network node 102 and may have some relaying capability, i.e. UE node 130 may act as a UE-to-network (U2N) relay UE at some time, even though it is not serving any remote UE at the time represented in FIG. 1.

The network nodes 101 and 102 may be base stations of a wireless network, such as a fifth-generation (5G) New Radio (NR) network or a Long Term Evolution (LTE) network. FIG. 1 only shows the base stations of the wireless network for clarity. For a 5G NR network, the network node 101, or 102, is referred to as a gNB.

Even though sidelink relay is most likely to be considered in the context of V2X networks, it is not intended that the invention is limited to UE nodes that are in or part of a vehicle. Each of the UE nodes (relay or remote) may be a wireless communication device located in or part of a vehicle or a Road Side Unit (RSU) or a wireless communication device of a Vulnerable Road User (VRU) (e.g. a mobile or portable communication device (such as a smart phone, PDA, laptop, or similar devices) of a pedestrian or cyclist). In the following, a relay UE node will also be referred to as a relay UE, a remote UE node will also be referred to as a remote UE and a network node will be referred to as a gNB. Although in the following description, embodiments and examples of embodiments of the present invention will be described with respect to a 5G NR network, it will be appreciated that it is not intended that the present invention is limited to 5G NR systems and may be used in any wireless communication systems supporting sidelink (or peer to peer) relay communications.

In an example shown in FIG. 1, in a UE-to-Network (or U2N) scenario with the UE 110 (or UE 120) operating as UE-to-Network relay UE, the UE-to-Network relay UE 110 (or relay UE120) connects the UEs 111 and 112 (or UE 121), operating as remote UEs, to the gNB 101 (or gNB 102). The remote UE 111 is connected to the relay UE 110 via or through a sidelink 111a which may be referred to as a PC5 hop or link or connection or interface 111a. Similarly, remote UE 112 and remote UE 121 have PC5 hops, or links or connections or interfaces 112a and 121a respectively with the relay UE 110 and relay UE 120. A Uu hop or link or connection or interface 110a connects the relay UE 110 to the gNB 101, while a Uu hop or link or connection or interface 120a and 130a respectively connect the relay UE 120 and the UE 130 to the gNB 102. PC5 connections are used for the relayed traffic of the remote UEs (111, 112 and 121) and the non-relayed traffic specific to the relay UE 110, 120, i.e. for the direct communications between relay UE 110, 120 and the other remote UEs (111, 112 and 121). Therefore, the remote UE 111 is connected to the gNB 101 through the relay UE 110 with a PC5 hop 111a and a Uu hop 110a. For uplink communication, the remote UE 111 is the source node (or transmitter node for transmitting data) and the gNB 101 is the destination or target node (or receiver node for receiving data) for a sidelink relay connection established between the remote UE 111 and the gNB 101 with a PC5 hop 111a and a second Uu hop 110a and for downlink communication, the remote UE 111 is the destination or target node (or receiver node) and the gNB 101 is the source node (or transmitter node). Similarly, the remote UE 121 is connected to the gNB 102 through the relay UE 120 with a PC5 hop 121a and a Uu hop 120a.

At some point, the gNB 101, acting as a source gNB, may decide to hand over the relay UE 110 to the gNB 102, which would then act as a target gNB. For example, in the case where the radio conditions in the serving cell (not shown in FIG. 1) controlled by the source gNB 101 deteriorate such that the radio conditions in the target cell (not shown in FIG. 1) controlled by the target gNB 102 are better than the serving cell, the source gNB 101 may decide to handover the relay UE 110 to the target gNB 102. In such a case, the relay UE 110 would detach from the source gNB 101, thereby releasing the Uu link 110a to further connect to the target gNB 102 through Uu link 110b (shown in dotted lines in FIG. 1) established as part of a re-establishment procedure.

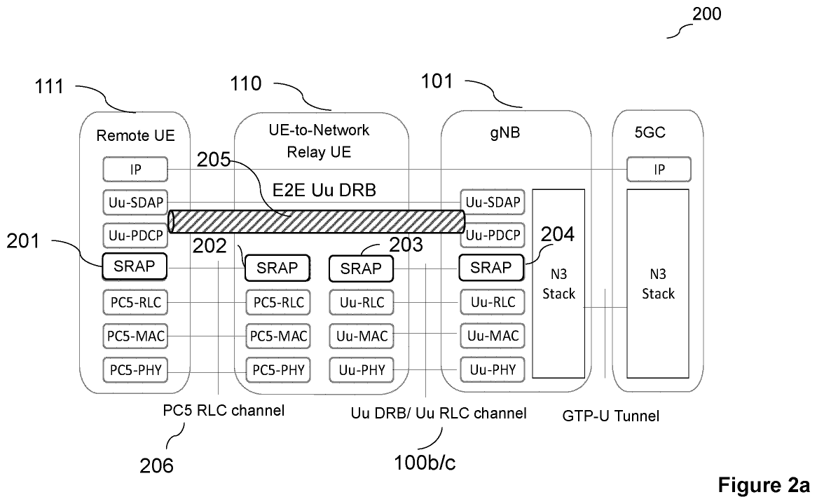

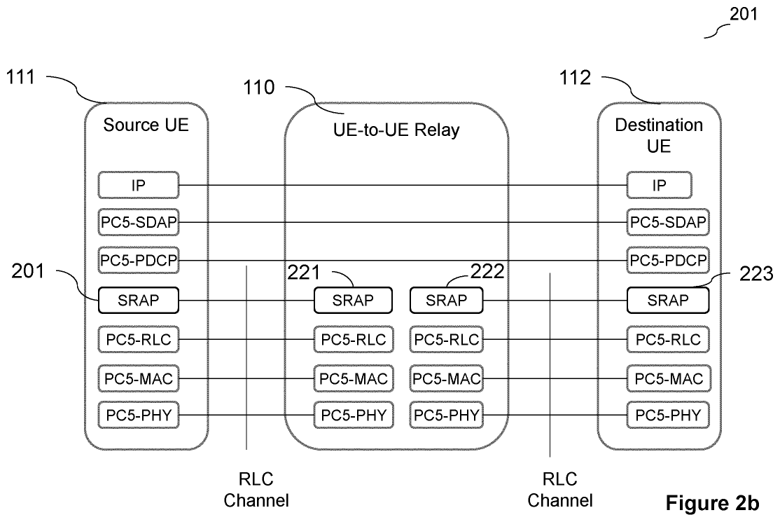

In order to set up a relayed traffic between a first node (remote UE) and a second node (gNB or remote UE), a Sidelink relay architecture may be used according to the 3GPP TR 38.836. The user plane architecture or protocol stack is shown in FIG. 2a and FIG. 2b and represents the Sidelink Relay adaptation layer called SRAP that is introduced between the PDCP layer and the RLC layer at the extreme nodes and above the RLC layer in the relay UE. This architecture was first documented in the TR 38.836 and finally refined in 3GPP TS 38.300 while the SRAP layer is defined in 3GPP TS 38.351.

This architecture shown in FIG. 2a shows the Sidelink relay architecture 200 for the UE-to-Network relay scenario. The architecture shown in FIG. 2b shows the Sidelink relay architecture 201 for the UE-to-UE relay scenario which, as shown in FIG. 2b, is similar to that shown in FIG. 2a. However, the relay UE in the UE-to-UE relay case has two PC5 SRAP entities or layers 221 and 222. As shown in FIG. 2a for the UE-to-Network relay scenario, the remote UE, such as remote UE 111, has a PC5 SRAP layer 201 between its Uu PDCP layer and it PC5 RLC layer.

As shown in FIG. 2a for the UE-to-Network relay scenario, at the relay UE, such as relay UE 110, there are two SRAP layers to interface with the PC5 hop 111a and the Uu hop 110a: the PC5 SRAP layer 202 is connected to the PC5 SRAP 201 of the remote UE 111 through the PC5 hop 111a; and the Uu SRAP layer or entity 203 is connected to the Uu SRAP layer 204 at the gNB side 101 through the Uu link 110a. A remote UE 111 establishes End-to-End radio bearers 205 with the gNB 101. These radio bearers could be a Signalling Radio Bearer SRB or Data Radio Bearer DRB. FIG. 2 shows an E2E Uu DRB between the remote UE 111 and the gNB 101 by way of example.

The PC5 SRAP layer 202 of the UE-to-Network relay UE 110 receives data or packets (traffic data or signalling) over or via ingress PC5 RLC channels 206 from remote UE 111 (at PC5 hop 111a) in an uplink direction and transmits the packets to the Uu SRAP entity 203 of the same relay UE 110.

The Uu SRAP 203 entity will map the corresponding ingress PC5 RLC channels 206 to egress Uu RLC channels 100b and/or 100c at Uu link 110a. Thus, a mapping table is required for uplink and it is configured by gNB 101 at the Uu SRAP entity 203 of the relay UE 110.

The mapping table takes at its input an identifier of the remote UE 111 (e.g. L2-ID), an identifier of the E2E radio bearer 205 (e.g. the E2E Uu DRB 205 ID) and an identifier of the ingress PC5 RLC channel (or bearer) 206 and identifies the egress Uu RLC bearer ID where the E2E radio bearers are mapped. For example, the UE E2E bearer ID and remote UE ID can be obtained from the header of a data packet received at the Uu SRAP entity 203. An example of an entry for an uplink mapping table with one entry configured at the Uu SRAP entity 203 is shown in Table 1 below. It will be appreciated that the mapping table will be configured so that it has an entry for each remote UE connected to the relay UE.

TABLE 1

| UE | E2E Uu | Ingress PC5 RLC | Egress Uu RLC |
|---|---|---|---|
| ID | DRB ID | channel ID | channel ID |
| x1 | y1 | z1 | w1 |

At the Uu side or link 110a, different radio bearers of the same remote UE or different remote UEs can be subject to N:1 mapping and data multiplexing over Uu RLC channels 100b and 100c.

In the downlink direction, data or packets transmitted from gNB 101 arrive at the relay UE 110 through the Uu link 110a. The ingress Uu RLC channels 100b and 100c at the Uu SRAP entity 203 of the relay UE 110 will be mapped to the egress PC5 RLC channels 206 at PC5 hop 111a. The corresponding packets in downlink will be transmitted from the Uu SRAP entity 203 to the PC5 SRAP entity 202 to be then transmitted through the PC5 RLC channels 206 to the remote UE 111. Thus, a mapping table is required for downlink and it is configured by the gNB 101 at Uu SRAP entity 203 of the relay UE 110. The mapping table requires at its input the remote UE 111 L2-ID, the End-to-End radio bearer 205 ID and the ingress Uu RLC channel (or bearer) 100b and 100c ID and delivers the egress PC5 RLC channels (or bearer) 206 ID to the PC5 SRAP entity 202 of the same relay UE 110. The End-to-End Radio bearer 205 is then mapped at the PC5 hop 111a to the egress PC5 RLC channels 206. For example, the UE E2E bearer ID and remote UE ID can be obtained from the header of a packet received at the Uu SRAP entity 203. An example of a downlink mapping table with one entry configured at the Uu SRAP entity 203 is shown in Table 2 below. It will be appreciated that the mapping table will be configured so that it has an entry for each remote UE connected to the relay UE.

TABLE 2

| UE | E2E Uu | Egress PC5 RLC | Ingress Uu RLC |
|---|---|---|---|
| ID | DRB ID | channel ID | channel ID |
| x2 | y2 | z2 | w2 |

As mentioned in 3GPP TS 38.351, each SRAP entity has a transmitting part and a receiving part. Across the PC5 interface 111a, the transmitting part of the PC5 SRAP entity 201 at the remote UE 111 has a corresponding receiving part at PC5 SRAP entity 202 at the UE-to-Network Relay UE 110, and vice-versa. Across the Uu interface 110a, the transmitting part of the Uu SRAP entity 203 at the UE-to-Network Relay UE 110 has a corresponding receiving part at Uu SRAP entity 204 at the gNB 101, and vice-versa.

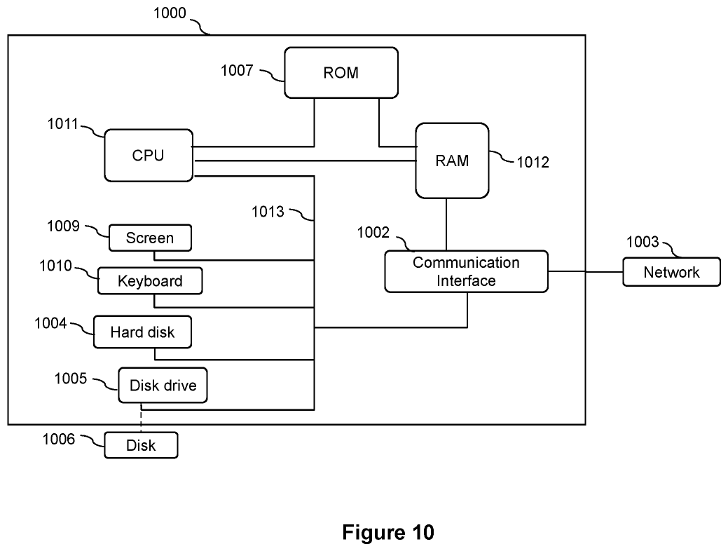

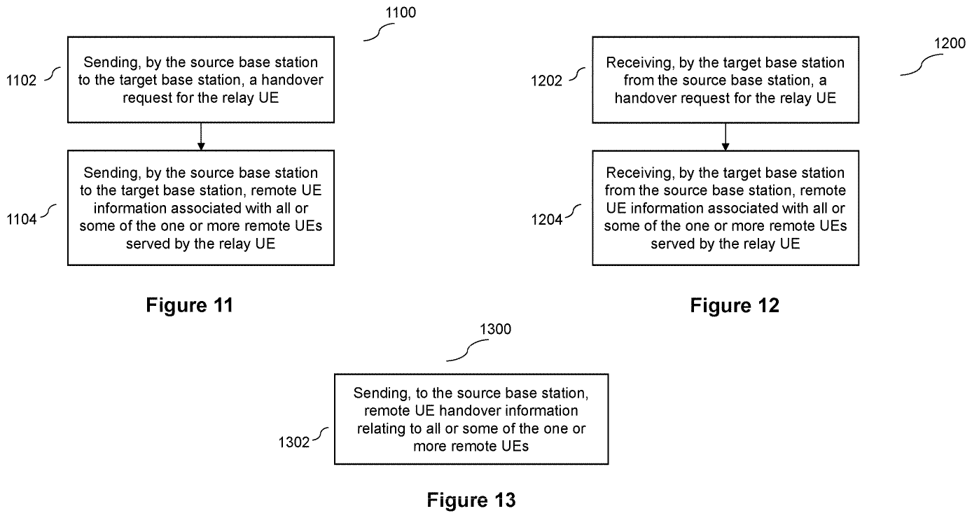

Referring now to FIG. 11 which is a flow chart showing steps of a method 1100 performed at a source base station. Method 1100 is for use in managing handover of a relay UE, from the source base station (e.g. a network node) to a target base station, with the relay UE serving (or being wirelessly connected to) one or more remote UEs via one or more sidelink connections or sidelinks. The source and target base station support sidelink relaying and with the relay UE, are part of a sidelink relay network of a wireless communication system. The wireless communication system may be, for example, the wireless communication system 100 of FIG. 1. With respect to the example shown in FIG. 1, the source base station performing method 1100 may be source base station 101 (also referred to as source gNB 101), the target base station may be target base station 102 (also referred to as target gNB 102), the relay UE may be relay UE 110 and the one or more remote UEs may be remote UEs 111 and 112. The method 1100 as shown in and described with respect to FIG. 11 may be performed by software elements and/or hardware elements. Thus, for example, the method as shown in and described with respect to FIG. 11 may be performed by an apparatus for the source gNB comprising one or more processing units configured to carry out the method. The source gNB may be implemented in a communication device 1000 as shown in and described with reference to FIG. 10 with the method as shown in and described with respect to FIG. 11 being performed by one or more processing units, such as the central processing unit 1011.

Briefly, at step 1102, the source gNB 101 sends, to the target gNB 102, a handover request for the relay UE 110. The handover request may indicate that the UE for which a handover has been requested is a relay UE. For example, the handover request may include sidelink relay UE handover information for indicating that the UE 110 for which a handover has been requested is a relay UE and/or a handover request identifier for uniquely identifying the handover request for the relay UE. In an example, the handover request is sent in a handover request message for the relay UE 110 (such as HANDOVER REQUEST message 313, 313a, 313b as discussed in more detail below). At step 1104, the source gNB 101 sends, to the target gNB 102, remote UE information associated with all or some (or part) of the one or more remote UEs served by the relay UE 110. In other words, the source gNB 101 sends remote UE information associated with or related to at least one of the one or more remote UEs served by the relay UE 110. Thus, the source gNB 101 sends remote UE information associated with all or some of the one or more remote UEs served by the relay UE as part of managing handover of the relay UE to negotiate the handover of the relay UE 110 and all or some of the remote UEs served by the relay UE 110.

By providing remote UE information for all or some of the remote UEs served by the relay UE 110 to the target gNB 102 prior to when handover of the remote UEs is executed (e.g. by providing remote UE information as part of managing handover of the relay UE 110 or when negotiating handover of the relay UE between the source gNB and target gNB), the management of handover of the relay UE and remote UEs served by the relay UE to the target gNB 102 and/or execution of handover of the relay UE and remote UEs when the relay UE 110 is handed over to the target gNB 102, is faster and more efficient. For example, as part of handover management, the remote UE information can help the target gNB 102 determine whether the handover of the relay UE 110 and/or all or some of the remote UEs can be accepted which may allow the target gNB to better evaluate the potential impact of the relay UE and the remote UEs served by the relay UE on the performance of the network cell managed by the target gNB 102. For example, it could be the case that the target gNB 102 has resources to serve a relay UE but not any of the remote UEs served by the relay UE. With the remote UE information, the target gNB 102 may then decide to not accept the handover request from the relay UE. In another example, as part of handover execution where the remote UE information includes context information for the all or some of the remote UEs (which is discussed in more detail below), by sharing context information for the remote UEs, handover of the remote UEs from the source gNB 101 to the target gNB 102 is faster and more efficient as the remote UEs would then not need to share this context information with the target gNB 102 when performing handover and connection reestablishment upon relay UE 110 handover.

The remote UE information sent by the source gNB 101 is associated with all or some of the remote UEs. The all or some of the remote UEs may include the remote UEs of the UEs served by the relay UE 110 which would remain connected to the relay UE after handover for the relay UE is completed. For example, the all or some of the remote UEs may include at least one remote UE of the one or more remote UEs having a certain relationship with the relay UE and/or at least one remote UEs of the one or more remote UEs which wishes to remain connected to the relay UE after handover for the relay UE is completed (for example, on execution of handover) and/or at least one remote UE of the one or more remote UEs that are also directly connected to the source base station. The certain relationship may be a strong or close interactive relationship and may be based on a relationship which is additional to being wirelessly connected to or served by the relay UE 110, such as having applications which interact with applications on the relay UE. As discussed below, a remote UE having a certain relationship with a relay UE is referred to as a bounded remote UE.

Remote UE handover information relating to the remote UE(s) served by the relay UE 110 may be received at the source gNB 101 and the source gNB 101 may determine or provide the remote UE information for sending to the target gNB 102 based on the received remote UE handover information. The remote UE handover information may be received from the relay UE 110. For example, the remote UE handover information may be received in a REMOTE UE INFORMATION message 311 as discussed below. In an example, the remote UE handover information may be received in response to a request from the source gNB 101 (e.g. in a REMOTE UE INFORMATION REQUEST message 310 as discussed below). The remote UE handover information is associated with the remote UEs of the one or more remote UEs served by the relay UE 110 that would remain connected to the relay UE 110 after handover of the relay UE 110 is completed and may include information indicating the remote UEs of the one or more remote UEs served by the relay UE 110 that would remain connected to the relay UE 110 after handover of the relay UE 110 (e.g. to the target gNB 102) is completed. The remote UE handover information may include at least one of: list of remote UEs information for indicating at least one of the number and the identifiers of the one or more remote UEs that would remain connected to the relay UE after handover for the relay UE is completed (e.g. List of Remote UEs information as discussed below); list of bounded remote UEs information for indicating at least one of the number and the identifiers of the remote UEs having a certain relationship with the relay UE (e.g. List of Bounded Remote UEs information as discussed below); remote UE requirement information for indicating communication requirements for at least one of the all or some of the one or more remote UEs (e.g. Remote UE Requirements list information as discussed below).

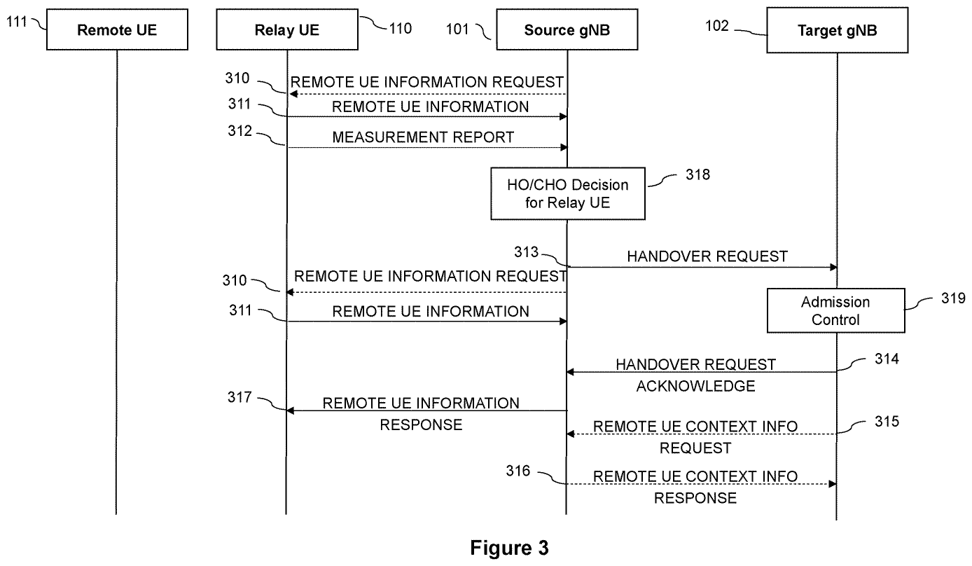

Remote UE information for the all or some of the remote UEs (e.g. for those remote UEs served by the relay UE 110 that would remain connected to the relay UE 110 on handover of the relay UE to the target gNB 102) may be sent to the target gNB 102 as part of managing the handover of the relay UE and may be sent at different times. For example, remote UE information may be sent only with the handover request for the relay UE 110 in a handover request message for the relay UE 110 that is sent to the target gNB 102; or some remote UE information may be sent to the target gNB 102 with the handover request message for the relay UE 110 and some other remote UE information may be sent to the target gNB 102 in at least one different message (e.g. after sending the handover request for the relay UE); or the remote UE information may be sent separately to the handover request message for the relay UE 110 in at least one different message (e.g. after sending the handover request for the relay UE). Examples of different messages that can be used to send remote UE information are discussed below with reference to FIGS. 3-9.

Remote UE information includes at least one of (based at least in part on similar remote UE handover information received from the relay UE 110): sidelink remote UE handover information for indicating that the UE for which a handover has been requested is a remote UE (e.g. Sidelink Remote UE Handover information as discussed below); list of remote UEs information for indicating at least one of the number and the identifiers of the remote UEs which would remain connected to the relay UE after handover to the target gNB 102 for the relay UE is completed (e.g. List of Remote UEs information as discussed below); list of bounded remote UEs information for indicating at least one of the number and the identifiers of the one or more remote UEs having a certain relationship with the relay UE (e.g. List of Bounded Remote UEs information as discussed below); list of multipath remote UEs information for indicating at least one of the number and the identifiers of the one or more remote UEs also directly connected to the source base station (e.g. List of Multipath Remote UEs information as discussed below); remote UE context information including context information (such as radio resource configuration information) for at least one of the all or some of the one or more remote UEs (e.g. Remote UE Context Information list information as discussed below); remote UE requirement information for indicating communication requirements (such as, Quality of Service (QoS) requirements and/or bit rate requirements and/or load requirements) for at least one of the all or some of the one or more remote UEs (e.g. Remote UE Requirements list information as discussed below).

In one example, the remote UE information is sent by the source gNB 101 to the target gNB 102 with the handover request message for the relay UE. Such a handover request message may comprise the HANDOVER REQUEST message 313 which, in addition to sidelink relay UE handover information indicating the handover request is for a relay UE, may include remote UE quantity information for indicating a quantity of resource required at the target base station for the all or some of the one or more remote UEs served by the relay UE and remote UE context information including context information for at least one remote UE of the all or some of the one or more remote UEs. Such a message may also include the remote UE requirement information. The remote UE quantity information may include: at least one of the number and identifier(s) of the remote UEs of the one or more remote UEs that would remain connected to the relay UE 110 on completion of handover to the target gNB 102 (may be all or some (or part) of the one or more Remote UEs and indicated for example, by one or more of: list of remote UEs information (e.g. List of Remote UEs information as discussed below); list of bounded remote UEs information (e.g. List of Bounded Remote UEs information as discussed below); list of multipath remote UEs information (e.g. List of Multipath Remote UEs information as discussed below); and/or resource load associated with the remote UEs of the one or more remote UEs that would remain connected to the relay UE 110 on completion of handover to the target gNB 102.

In another example, some remote UE information (e.g. first remote UE information) is sent by the source gNB 101 to the target gNB 102 with the handover request message for the relay UE 110 and some other remote UE information (e.g. second remote UE information) is sent by the source gNB 101 in at least one different message, which is different to the handover request message for the relay UE 110. The first and second remote UE information may be completely different or there may be some overlap. The first remote UE information may include remote UE quantity information as discussed above. The second remote UE information may include remote UE context information as discussed above. In an example, the first or second remote UE information may also include remote UE requirement information as discussed above. In this case, the remote UE requirement information may be sent with the remote UE context information in the different message or may be sent in another different message. By providing context information for the remote UEs to the target gNB 102 prior to when handover of the remote UEs is executed (e.g. providing context information as part of managing handover of the relay UE 110 or when negotiating handover of the relay UE 110 between the source gNB and target gNB), executing handover of the remote UEs to the target gNB 102, when the relay UE 110 is handed over to the target gNB 102, is faster and more efficient.

In this case, the handover request message for the relay UE 110 may comprise the HANDOVER REQUEST message 313a as discussed below. The at least one different message may be a HANDOVER REQUEST message for at least one of the remote UEs which would remain connected to the relay UE after handover to the target gNB 102 for the relay UE is completed. Such a handover request message may comprise the HANDOVER REQUEST message 515 or the HANDOVER REQUEST messages 313u as discussed below. The at least one additional message may include a context message which includes context information, such as the REMOTE UE CONTEXT INFO RESPONSE message 316 or 518 and/or the REMOTE UE CONTEXT TRANSFER message 415, and which context message may be sent by the source gNB 101 in response to a message received from the target gNB 102 (e.g. the REMOTE UE CONTEXT INFO REQUEST message 315, 517 or the HANDOVER REQUEST ACKNOWLEDGE message 314).

In another example, the source gNB 101 sends a handover request message for the relay UE 110 including the handover request for the relay UE and sends the remote UE information in a least one different message to the handover request message for the relay UE. The remote UE information included in a different message may include remote UE quantity information and remote UE context information as discussed above. In another example, some remote UE information (e.g. first remote UE information) is sent with a first different message and some other remote UE information (e.g. second remote UE information) is sent in a second different message, which is different to the first different message and which are both different to the handover request message for the relay UE 110. The first and second remote UE information may be completely different or there may be some overlap. The first remote UE information may include remote UE quantity information as discussed above. The second remote UE information may include remote UE context information as discussed above. In an example, the first or second remote UE information may also include remote UE requirement information as discussed above.

In this case, the handover request message for the relay UE 110 may comprise the HANDOVER REQUEST message 313b as discussed below. The at least one different message may be at least one HANDOVER REQUEST message for at least one of the remote UEs which would remain connected to the relay UE after handover to the target gNB 102 for the relay UE is completed. Such a handover request message may comprise the HANDOVER REQUEST message 515 or the HANDOVER REQUEST messages 313u as discussed below.

The at least one additional message may include a context message including context information, such as the REMOTE UE CONTEXT INFO RESPONSE message 316 or 518 and/or the REMOTE UE CONTEXT TRANSFER message 415, may be sent by the source gNB 101 in response to a message received from the target gNB 102 (e.g. the REMOTE UE CONTEXT INFO REQUEST message 315, 517 or the HANDOVER REQUEST ACKNOWLEDGE message 314).

In an example, the source gNB 101 receives handover status information (handover grant status information or handover acceptance status information) indicating handover granted or acceptance status for the relay UE 110 and/or all or some of the one or more remote UEs served by the relay UE 110. The handover status information may comprise Handover Granted List information which may be included in a HANDOVER REQUEST ACKNOWLEDGE message (such as message 314 or 516) or a REMOTE UE CONTEXT TRANSFER ACKNOWLEDGE message 416a as discussed below. In the cases where the context information is sent separately (e.g. in a context message including context information, such as the REMOTE UE CONTEXT INFO RESPONSE message 316 or 518 and/or the REMOTE UE CONTEXT TRANSFER message 415) to the handover request for the relay UE 110 and the handover request for the remote UEs and after the handover status information is received, when sending context information to the target gNB 102, the context information can be sent based on the handover status information: for example, the source gNB 101 can send context information only for the remote UEs for which handover is accepted. Thus, by sending context information only for the remote UEs accepted for handover instead of sending context information for each of the all or some of the one or more remote UEs, the amount of information transmitted is limited to what is needed which helps to minimise the resources (processing and signalling) used.

In response to receiving the handover status information, the source gNB 101 may send to the relay UE 110, remote UE handover status information indicating the remote UEs of the one or more remote UEs that have been accepted by the target gNB 101 for handover. For example, remote UE handover status information may be included in a message such as REMOTE UE INFORMATION RESPONSE message 317 as discussed below.

The handover may be a normal or legacy handover (HO) or conditional handover (CHO). Thus, the handover request may be a HO request or a CHO request. As discussed below for normal or legacy HO, the source gNB decides whether to initiate a handover to a target gNB based on signal measurements received from the relay UE. For CHO, the source gNB, based on signal measurements received from the relay UE, allows the relay UE to initiate handover to a target gNB (which could be one of several candidate target gNBs) when certain handover execution conditions (which have been configured for the relay UE by the source gNB) are met. For both HO and CHO, the source gNB 101 determines or decides (e.g. at 318 as shown in FIGS. 3-5), based on signal measurements received from the relay UE 110 (e.g. in measurement reports 312 as described below), whether HO/CHO is to be performed for the relay UE 110 and/or all or some of the remote UEs served by the relay UE 110 and then as part of managing HO/CHO of the relay UE 110, the source gNB 101 sends the handover request for the relay UE 110 (step 1102) and sends the remote UE information (step 1104). More details of CHO are set out in clause 9.2.3.4 of 3GPP TS 38-300 v 17.1.0. For CHO, there may be more than one candidate target gNB (the relay UE selects one of the candidate target gNBs as the target gNB when the handover execution conditions are met) and so the handover request and the remote UE information may be sent by the source gNB 101 to each of the candidate target gNBs (i.e. to more than one target gNB).

Referring now also to FIG. 12 which is a flow chart showing steps of a method 1200 performed at a target base station. Method 1200 is for use in managing handover of a relay UE, from a source base station (e.g. a network node) to the target base station, with the relay UE serving (or being wirelessly connected to) one or more remote UEs via one or more sidelink connections or sidelinks. The source and target base station support sidelink relaying and with the relay UE, are part of a sidelink relay network of a wireless communication system. The wireless communication system may be, for example, the wireless communication system 100 of FIG. 1. With respect to the example shown in FIG. 1, the target base station performing method 1200 may be target base station 102 (also referred to as target gNB 102), the source base station may be source base station 101 (also referred to as source gNB 101), the relay UE may be relay UE 110 and the one or more remote UEs may be remote UEs 111 and 112. The method 1200 as shown in and described with respect to FIG. 12 may be performed by software elements and/or hardware elements. Thus, for example, the method as shown in and described with respect to FIG. 12 may be performed by an apparatus for the target gNB comprising one or more processing units configured to carry out the method. The target gNB may be implemented in a communication device 1000 as shown in and described with reference to FIG. 10 with the method as shown in and described with respect to FIG. 12 being performed by one or more processing units, such as the central processing unit 1011.

Briefly, at step 1202, the target gNB 101 receives, from the source gNB 101, a handover request for the relay UE 110. The handover request may indicate that the UE for which a handover has been requested is a relay UE. For example, the handover request may include sidelink relay UE handover information for indicating that the UE 110 for which a handover has been requested is a relay UE and/or a handover request identifier for uniquely identifying the handover request for the relay UE 110. In an example, the handover request is received in a handover request message for the relay (such as HANDOVER REQUEST message 313, 313a, 313b as discussed in more detail below). At step 1204, the target gNB 102 receives, from the source gNB 101, remote UE information associated with all or some (or part) of the one or more remote UEs served by the relay UE 110. In other words, the target gNB 102 receives remote UE information associated with or related to at least one of the one or more remote UEs served by the relay UE 110. The target gNB 102 receives remote UE information associated with all or some of the one or more remote UEs served by the relay UE as part of managing handover of the relay UE to negotiate the handover of the relay UE 110 and all or some of the remote UEs served by the relay UE 110. The messages sent by the source gNB 101 to the target gNB 102 and the messages received by the source gNB 101 from the target gNB 102 as described above with reference to FIG. 11 correspond to messages received at the target gNB 102 from the source gNB 101 and messages sent by the target gNB 102 to the source gNB 101 and thus, the above description for such messages can be applied to messages received at and sent by the target gNB 102 and the details will not be repeated here.

After receiving the handover request for the relay UE 110 and the remote UE information for the all or some of the one or more remote UEs, the target gNB 102 may determine whether handover of the relay UE can be accepted based on the handover request for the relay UE and/or whether handover of the all or some of the one or more remote UEs can be accepted based on the received remote UE information. The target gNB 102 may make such a determination as part of an Admission Control process (e.g. at 319 as shown in FIGS. 3-5) as discussed in more detail below.

By providing remote UE information for all or some of the remote UEs served by the relay UE 110 to the target gNB 102 prior to when handover of the remote UEs is executed (e.g. by providing remote UE information as part of managing handover of the relay UE 110 or when negotiating handover of the relay UE between the source gNB and target gNB), the management of handover of the relay UE and/or the remote UEs served by the relay UE to the target gNB 102 and/or execution of handover of the relay UE and remote UEs when the relay UE 110 is handed over to the target gNB 102, is faster and more efficient. For example, having the knowledge of the number of remote UEs served by the relay UE 110 and/or the knowledge of the requirements (e.g. bitrate, QoS . . . ) of each of these remote UEs may allow the target gNB to better evaluate the potential impact of these remote UEs on the performance of the network cell managed by the target gNB 102 if the remote UEs were to join this cell. In an example, the target gNB 102 may give precedence for handover acceptance to the Bounded remote UEs or to the remote UEs having some multipath connectivity that involves the relay UE 110 or to the remote UEs that have less impact on the performance of the cell controlled by the target gNB 102.

Referring now also to FIG. 13 which is a flow chart showing steps of a method 1300 performed at a relay UE. Method 1300 is for use in managing handover of a relay UE, from a source base station (e.g. a network node) to the target base station, with the relay UE serving (or being wirelessly connected to) one or more remote UEs via one or more sidelink connections or sidelinks. The source and target base station support sidelink relaying and with the relay UE, are part of a sidelink relay network of a wireless communication system. The wireless communication system may be, for example, the wireless communication system 100 of FIG. 1. With respect to the example shown in FIG. 1, the relay UE performing method 1300 may be relay UE 110, the target base station may be target base station 102 (also referred to as target gNB 102), the source base station may be source base station 101 (also referred to as source gNB 101), and the one or more remote UEs may be remote UEs 111 and 112. The method 1300 as shown in and described with respect to FIG. 13 may be performed by software elements and/or hardware elements. Thus, for example, the method as shown in and described with respect to FIG. 13 may be performed by an apparatus for the relay UE comprising one or more processing units configured to carry out the method. The relay UE may be implemented in a communication device 1000 as shown in and described with reference to FIG. 10 with the method as shown in and described with respect to FIG. 13 being performed by one or more processing units, such as the central processing unit 1011.

Briefly, at step 1302, the relay UE 110 sends, to the source gNB 101, remote UE handover information relating to all or some of the one or more remote UEs. The remote UE handover information indicates the remote UEs of the one or more remote UEs that would remain connected to the relay UE after handover of the relay UE is completed. The remote UE handover information is associated with the remote UEs of the one or more remote UEs served by the relay UE 110 that would remain connected to the relay UE 110 after handover of the relay UE 110 is completed and may include information indicating the remote UEs of the one or more remote UEs served by the relay UE 110 that would remain connected to the relay UE 110 after handover of the relay UE 110 (e.g. to the target gNB 102) is completed. The remote UE handover information may include at least one of: list of remote UEs information for indicating at least one of the number and the identifiers of the one or more remote UEs that would remain connected to the relay UE after handover for the relay UE is completed (e.g. List of Remote UEs information as discussed below); list of bounded remote UEs information for indicating at least one of the number and the identifiers of the remote UEs having a certain relationship with the relay UE (e.g. List of Bounded Remote UEs information as discussed below); remote UE requirement information for indicating communication requirements for at least one of the all or some of the one or more remote UEs (e.g. Remote UE Requirements list information as discussed below). The relay UE 110 may send the remote UE handover information in a REMOTE UE INFORMATION message 311 as discussed below. In an example, the remote UE handover information may be sent in response to a request from the source gNB 101 (e.g. in a REMOTE UE INFORMATION REQUEST message 310 as discussed below).

More details regarding messages sent/received by the source gNB 101 and the target gNB 102 are given below in the description with reference to FIGS. 3-9.

FIG. 3, FIG. 4 and FIG. 5 are schematic and simplified diagrams illustrating some example message flows for managing Relay UE legacy handover (HO) or Relay UE conditional handover (CHO) according to embodiments of the invention. The message flows are described with reference to the wireless communication system of FIG. 1 where a Relay UE is UE 110 serving Remote UE 111. The Relay UE 110 is served by a cell controlled by gNB 101, which is referred to as the source gNB 101, and a neighbouring cell is controlled by gNB 102 which is a target gNB 102 (or a candidate target gNB) for the Relay UE 110. Although the Figures only show messages exchanged between the source gNB and a target gNB, for CHO there may be more than one candidate target gNB (the relay UE selects one of the candidate target gNBs as the target gNB when the handover execution conditions are met for at least one of the candidate target gNBs) and so the messages (e.g. the handover request and the remote UE information) may be exchanged between the source gNB 101 and each of the candidate target gNBs (i.e. to more than one target gNB).

Some of the messages and steps performed at the different nodes in these figures are the same and these messages and steps are referred to with the same reference numbers.

A UE node, like Relay UE 110, may send some MEASUREMENT REPORT message 312, as illustrated on FIG. 3, to the gNB 101 it is connected to, in order to report on the signal strength with its source cell, managed or controlled by source gNB 101, and on the signal quality with its neighbour cell(s) (such as the cell managed or controlled by gNB 102). In this respect, 3GPP TS 38.331 specification defines some predefined sets of measurement report mechanism to be performed by UE, also referred to as “Event”. The main quantities measured and reported by Relay UE 110 may include: Synchronization Signal Reference Signal Received Power (SS-RSRP), Synchronization Signal Reference Signal Received Quality (SS-RSRQ), Synchronization Signal Signal-to-interference-plus-noise ratio (SS-SINR), Channel State Information Reference Signal (CSI-RS), Channel State Information Reference Signal Received Power (CSI-RSRP), Channel State Information Reference Signal Received Quality (CSI-RSRQ), Channel State Information Signal-to-interference-plus-noise ratio (CSI-SINR) or Received Signal Strength Indicator (RSSI).

Based on the measurement reporting provided by MEASUREMENT REPORT message(s) 312, the source gNB 101 may further decide to initiate a handover (HO) procedure in order for the Relay UE to connect to the target gNB 102.

Alternately, based on the measurement reporting provided by MEASUREMENT REPORT message(s) 312, the source gNB 101 may allow the Relay UE 110 to decide whether or not to perform handover from source gNB 101 to target gNB 102 provided that some specific conditions are met. This procedure where the handover is executed by the Relay UE when it evaluates that one or more handover execution conditions, configured by the source gNB 101, are met is referred to as a Conditional Handover (CHO) process. In FIG. 3, the decision or determination by the source gNB 101 as to whether HO/CHO is to be performed for the relay UE 110 and/or all or some of the remote UEs served by the relay UE 110 is represented by box 318.

In both cases, the source gNB requests to the target gNB 102 the preparation of resources for a handover (HO) or a conditional handover (CHO) for the Relay UE 110 by issuing a handover request for the Relay UE 110 which may be included in a HANDOVER REQUEST message 313 sent to the target gNB 102, where message 313 includes a transparent RRC container with necessary information to prepare the handover at the target side. The list of the several information included in the Handover Request message 313 is discussed in 3GPP TS 38.300 v17.1.0 and 3GPP TS 38.423 V17.1.0.

As the Relay UE 110 is serving a plurality of Remote UEs, (e.g. Remote UE 111 and Remote UE 112), performing the handover (or the conditional handover) of the Relay UE 110 from source gNB 101 to target gNB 102 would imply all or part of the Remote UEs served by Relay UE 110 are to be handed over to the target gNB 102 based on the RRC re-establishment procedure as defined in 3GPP TS 38.300 v17.1.0. Therefore, the preparation of resources for Relay UE 110 handover (or conditional handover) at the target gNB 102 should take into account the impact of the handover for the Remote UEs 111 and 112 served by the Relay UE 110. Thus, remote UE information associated with all or part (or some) of the Remote UEs served by the Relay UE 110 is also sent to the target gNB 102.

Therefore, in an example, all or part of the following new Information Elements are sent to the target gNB 102: for example, by adding all or part of the following new Information Elements to the existing HANDOVER REQUEST message defined in 3GPP TS 38.423 V17.1.0:
Sidelink Relay UE Handover information. This information is used by the source gNB 101 to indicate to the target gNB 102 that the HO or CHO request is for a UE node that is currently acting as a Relay UE serving one or more Remote UEs. In one example, this information may also include a handover request identifier, which uniquely identifies the handover request for the considered Relay UE.
List of Remote UEs information. This information is used to indicate the number and/or the ID of the Remote UEs that would remain connected to the Relay UE 110 once it has completed its handover to the target gNB 102. In one example, the List of Remote UEs information refers to all the Remote UEs served by the Relay UE 110. In another example, the List of Remote UEs information refers to the Remote UEs served by the Relay UE that wish to remain connected to the Relay UE 110 once it has completed its handover to the target gNB 102.
List of Bounded Remote UEs information. This information is used to indicate the number and/or the ID of the Remote UEs that have a certain relationship with the Relay UE (e.g. the certain relationship is a strong or close interactive relationship and is based on a relationship which is additional to being wirelessly connected to or served by the Relay UE, such as having applications which interact with applications on the Relay UE). Some Remote UEs may have strong applicative interaction with the Relay UE 110 (e.g. the Remote UE may be a smart watch while the Relay UE may be a smart phone). Thus, such Remote UEs may wish to remain connected to this Relay UE 110 when it performs a handover (HO) or a conditional handover (CHO). Such Remote UEs may be referred to as bounded Remote UEs. In one example, the Relay UE 110 may inform its source gNB 101 about its bounded Remote UEs by sending the list or the number of bounded Remote UEs it is serving in a REMOTE UE INFORMATION message 311.
List of Multipath Remote UEs information. This information is used to indicate the number and/or the ID of the Remote UEs that are also directly connected to the Relay UE. Some Remote UEs may be connected to the Relay UE 110 as part of a multipath connection scheme where each of these Remote UEs also has a direct connection (Uu link) with the source gNB. Such Remote UEs may thus have specific interest in remaining connected to the Relay UE 110 when it performs a handover (HO) or a conditional handover (CHO).
Remote UE Context Information List information. This information gathers the UE Context Information Information Element (IE), i.e. UE context information which may include the radio resource configuration including local settings not configured across the radio interface, UE capabilities and radio resource management information, as defined in TS 38.423, for each of the Remote UEs that are to perform a handover (HO) to remain connected to the Relay UE 110 when the Relay UE 110 performs a handover (HO) or a conditional handover (CHO).

By sharing the Remote UE Context Information List information with the target gNB 102, the source gNB would allow a faster handover of these Remote UEs which would not need to share this information with the target gNB 102 when performing handover and connection reestablishment upon Relay UE 110 handover or conditional handover.
Remote UE Requirements List information. This information gathers, for each of the Remote UEs that are to be handed over to remain connected to the Relay UE 110 when the Relay UE 110 performs a handover (HO) or a conditional handover (CHO), some specific requirements (e.g. communication requirements) such as QoS requirements (e.g. a minimum QoS level, or a maximum QoS level, or an average QoS level) or some bitrate requirements (e.g. a minimum bitrate, ot a maximum bitrate, or average bitrate) or load requirements for the respective or considered Remote UE. In one example, information on these specific requirements may be provided to the source gNB 101 by the Relay UE 110 using the REMOTE UE INFORMATION message 311.

According to one example, information on these specific requirements includes a maximum aggregate bitrate for each PC5 link connecting a Remote UE to the Relay UE. This maximum aggregate bitrate information may be the NR UE Sidelink Aggregate Maximum Bit Rate defined TS 38.331 v17.1.0.

According to one example, information on these specific requirements includes a maximum relay aggregate bitrate (NR UE Sidelink RELAY Aggregate Maximum Bit Rate), i.e. the maximum bitrate for the data to be relayed by the Relay UE, for each PC5 link connecting a Remote UE to the Relay UE. This informs the target gNB about the data, related to Remote UE traffic, which are conveyed on Uu link.

The Sidelink Relay UE Handover information may be included in the handover request message for the Relay UE. The remote UE information associated with all or some (or part) of the one or more Remote UEs served by the Relay UE may include at least one of: remote UE quantity information for indicating a quantity of resource required at the target base station for the all or some of the one or more remote UEs served by the relay UE and remote UE context information including context information for at least one remote UE of the all or some of the one or more remote UEs. Such a message may also include the remote UE requirement information. The remote UE quantity information may include: at least one of the number and identifier(s) of the remote UEs of the one or more remote UEs that would remain connected to the relay UE 110 on completion of handover to the target gNB 102 (may be all or some (or part) of the one or more Remote UEs). In an example, the remote UE quantity information may include one or more of the List of Remote UEs information, List of Bounded Remote UEs information, List of Multipath Remote UEs information. The context information may include Remote UE Context Information List information. The remote UE information may include remote UE requirement information (e.g. Remote UE Requirements List information) for indicating communication requirements for each of the all or some of the one or more Remote UEs served by the Relay UE.

In an example, the source gNB 101 may issue a unitary HANDOVER REQUEST message for each of the Remote UEs it is serving, or for each of the Remote UEs that are to be handed over to remain connected to the Relay UE 110 when the Relay UE 110 performs a handover (HO) or a conditional handover (CHO). Such a HANDOVER REQUEST message will be referred to herein as HANDOVER REQUEST message 313u for ease of explanation (but the reference 313u is not shown in the figures: only a general HANDOVER REQUEST message 313 is shown in the figures). Each of these unitary HANDOVER REQUEST messages 313u may include all or part of the information a HANDOVER REQUEST message 313 may include, as previously described. For example, each unitary HANDOVER Request message 313u may include at least one of: an identifier for identifying the respective remote UE; remote UE context information including context information for the respective remote UE; multipath information for indicating whether the respective remote UE is also directly connected to the source base station; bounded information for indicating whether the respective remote UE has a certain relationship with the relay UE; list of multipath remote UEs information for indicating at least one of the number and the identifiers of the one or more remote UEs also directly connected to the source base station; remote UE requirement information for indicating communication requirements for the respective remote UE.

According to one aspect, in case the source gNB 101 is sending unitary HANDOVER REQUEST messages 313u and the source gNB 101 has sent, in the previous HANDOVER REQUEST message 313 related to Relay UE handover, the number and/or the ID of the Remote UEs list information included in the List of Remote UEs information, the target gNB 102 may rely on the number and/or the ID of the Remote UEs list information included in the List of Remote UEs information sent in the previous HANDOVER REQUEST message 313 related to Relay UE handover, to determine how many unitary HANDOVER REQUEST messages 313u it should receive.

In one aspect, the source gNB 101 may request the Relay UE 110 to send a REMOTE UE INFORMATION message 311 by issuing a REMOTE UE INFORMATION REQUEST message 310 to the Relay UE 110. For instance, when source gNB 101 intends to request a handover for the relay UE 110, it may be valuable for the gNB to get information related to Remote UEs (e.g. 111) served by the Relay UEs in order to refine the HANDOVER REQUEST message 313 (e.g. determine the information to be included in the HANDOVER REQUEST message for the relay UE 110) the source gNB 101 will send to target gNB 102. Thus, the source gNB requests the relay UE additional information by issuing REMOTE UE INFORMATION REQUEST message 310.

According to one aspect, the list of the Remote UEs that are to perform a handover (HO) to remain connected to the Relay UE 110 when the Relay UE 110 performs a handover (HO) or a conditional handover (CHO) is provided by the List of Remote UEs information and/or the List of Bounded Remote UEs information and/or List of Multipath Remote UEs information. In other words, remote UE quantity information for indicating a quantity of resource required at the target gNB for the remote UEs which would remain connected to the relay UE after the relay UE completes handover (which could be all or some of the remote UEs served by the relay UE) is sent to the target gNB and is provided at least by the List of Remote UEs information and/or the List of Bounded Remote UEs information and/or List of Multipath Remote UEs information.

Based on the information received from the source gNB 101, the target gNB 102 may perform some Admission Control (319) as mentioned in 3GPP TS 38.300 V17.1.0 (clause 9.2.3.2.1), in order to determine whether the handover of the Relay UE 110 and/or the handover of all or part of the Remote UEs served by the Relay UE 110 can be accepted. For example, when the HANDOVER REQUEST message 313 only includes information for the Relay UE 110 (e.g. the Sidelink Relay UE Handover information) and not remote UE information, the target gNB 102 may only determine whether handover of the Relay UE 110 can be accepted (at 319). When the HANDOVER REQUEST message 313 includes at least remote UE quantity information for indicating a quantity of resource required at the target gNB for the remote UEs which would remain connected to the relay UE after the relay UE completes handover (which could be all or some of the remote UEs served by the relay UE), the target gNB 102 can determine whether handover of the Relay UE 110 and at least some of the Remote UEs can be accepted (at 319).

The knowledge gained by the target gNB 102 from all or part of the Sidelink Relay UE Handover information, the List of Remote UEs information, the List of Bounded Remote UEs information, the List of Multipath Remote UEs information, the Remote UE Context Information List information and Remote UE Requirements List information, when included in a handover request message, allows the target gNB 102 to process the aforementioned admission control step (319) in a more efficient way. For example, the target gNB 102 can make the determination as to whether to accept handover of the Relay UE 110 and/or all or part of the Remote UEs served by the Relay UE 110 based on the current load of the target gNB 102 and the resources required by the Relay UE 110 and the remote UEs.

The target gNB 102 then prepares the handover for the UEs (i.e. Relay UE and all or part of the served Remote UEs) and sends to the source gNB 101 the HANDOVER REQUEST ACKNOWLEDGE message 314, which includes a transparent container to be sent to the considered UE(s) as an RRC message to perform the handover. In an example, the HANDOVER REQUEST ACKNOWLEDGE message 314 includes handover status information indicating whether the handover of the relay UE and/or all or some of the remote UEs connected to the relay UE has been accepted. For example, the HANDOVER REQUEST ACKNOWLEDGE message 314 may include a Handover Granted List information related to the UE(s) (i.e. Relay UE and all or part of the served Remote UEs) for which the handover or conditional handover is accepted.

This Handover Granted List information may indicate whether the HO/CHO for the Relay UE is accepted.

This Handover Granted List information may additionally or alternatively include the number and/or the ID of the Remote UEs connected to the Relay UE for which the gNB accepts a HO or a CHO.

Sharing the Handover Granted List information to the source gNB 101 may allow the source gNB to inform the Relay UE 110 about the Remote UEs that have been allowed by the target gNB 102 to be handed over to it (e.g. in a message 317 as discussed below).

In one example, in case the source gNB 101 issued unitary HANDOVER REQUEST messages 313u to the target gNB 102 for each of the Remote UEs the Relay UE 110 is serving, or for each of the Remote UEs that are to be handed over to remain connected to the Relay UE 110, the target gNB 102 may respond by sending, for each of the received unitary HANDOVER REQUEST messages 313u, a unitary HANDOVER ACKNOWLEDGE message (referred to herein as HANDOVER ACKNOWLEDGE message 314u for ease of explanation but the reference 314u is not shown in the figures and only a general HANDOVER ACKNOWLEDGE message 314 is shown in the figures), which indicates if the handing over of the corresponding Remote UE is accepted or not.

The source gNB 101 may then inform the Relay UE 110 about the Remote UEs that have been allowed by the target gNB 102 to be handed over to it, using the REMOTE UE INFORMATION RESPONSE message 317. Based on the Remote UEs handover status included in the REMOTE UE INFORMATION RESPONSE message 317, the Relay UE 110 may in turn notify its served remote UEs (e.g. Remote UE 111 and Remote UE 112) so that the remote UEs may adjust their connectivity with the Relay UE 110. For example, a Remote UE which would not be allowed to perform handover from the source gNB 101 to the target gNB 102 may decide to detach from the Relay UE 110 and perform relay reselection to identify a different Relay UE to connect with.

In an example of the invention, context information for the remote UEs may not be included in the HANDOVER REQUEST message 313: for example, when the Remote UE Context Information List information may not be included in the HANDOVER REQUEST message 313, which will be referred to herein as HANDOVER REQUEST message 313a for ease of explanation.

In such cases where the handover request does not include context information for the Remote UEs, the target gNB 102 may initiate a Retrieve UE Context procedure to retrieve the UE context of the Remote UEs that are allowed to perform a handover along with the Relay UE 110.

The target gNB 102 initiates this procedure by sending a message such as a REMOTE UE CONTEXT INFO REQUEST message 315 to the source gNB 101. In one example, the REMOTE UE CONTEXT INFO REQUEST message 315 is the RETRIEVE UE CONTEXT REQUEST message defined in 3GPP TS 38.423 V17.1.0.

According to one aspect, the REMOTE UE CONTEXT INFO REQUEST message 315 may include all or part of the following information:
Related Sidelink Relay UE Handover information. This information allows identifying the Relay UE that is serving the Remote UEs for which the UE context is requested by the target gNB 102;
List of Requested Remote UE Context information. This information indicates the number and/or the identifier of Remote UEs for which the UE context is requested by the target gNB 102.

Upon reception of the REMOTE UE CONTEXT INFO REQUEST message 315, the source gNB 101 may send back to the target gNB 102 a REMOTE UE CONTEXT INFO RESPONSE message 316 which may include context information such as the Remote UE Context Information List information, as previously defined for the HANDOVER REQUEST message 313. According to one aspect, the REMOTE UE CONTEXT INFO RESPONSE message 316 is the RETRIEVE UE CONTEXT RESPONSE message defined in 3GPP TS 38.423 V17.1.0.

Transmitting the Remote UE Context Information List information in the REMOTE UE CONTEXT INFO RESPONSE message 316, upon reception of a REMOTE UE CONTEXT INFO REQUEST message 315, instead of including this information as part of the HANDOVER REQUEST message 313 allows limiting the size, and thus the processing, of the HANDOVER REQUEST message 313 by sharing only the UE Context Information IEs for which a handover is to be accepted by the target gNB 102.

The target gNB 102 may benefit from the knowledge of the number or IDs of the remote UEs in order to perform efficient Admission Control. If such information is not present in the HANDOVER REQUEST message, the target gNB may have to accept (or reject) all the Remote UEs served by the Relay UE and when all of the Remote UEs have been accepted for handover, request the context for all the Remote UEs served by the Relay UE (e.g. using REMOTE UE CONTEXT INFO REQUEST message 315).

According to another aspect, only information for handover of the relay UE, such as only the Sidelink Relay UE Handover information, may be included in the HANDOVER REQUEST message 313, which will be referred to herein as HANDOVER REQUEST message 313b for ease of explanation (but reference 313b is not shown in the Figures). In such case, the HANDOVER REQUEST message 313b only aims at requesting the handover for the Relay UE 110. In case such a HANDOVER REQUEST message 313b is sent, the HANDOVER REQUEST ACKNOWLEDGE message 314 sent by the target gNB 102 to the source gNB may provide acknowledgement for the Relay UE 110 handover only.

According to one aspect, in case the source gNB 101 issued a HANDOVER REQUEST message 313 which does not include context information for the remote UEs (e.g. the HANDOVER REQUEST message is a HANDOVER REQUEST message 313a that was previously sent not including the Remote UE Context Information List information as discussed above or HANDOVER REQUEST messages 313u that were previously sent and do not include the Remote UE Context Information List information as discussed above or is a HANDOVER REQUEST message 313b only for the relay UE), and once having received a HANDOVER REQUEST ACKNOWLEDGE message 314, the source gNB 101 may issue a REMOTE UE CONTEXT TRANSFER message 415, as depicted in FIG. 4, so as to share the UE context of the Remote UEs that are to perform a handover along with the Relay UE 110. The REMOTE UE CONTEXT TRANSFER message 415 may include all or part of the following information:
Related Sidelink Relay UE Handover information. This information allows identifying the Relay UE that is serving the Remote UEs for which the UE context is shared with the target gNB 102. In one aspect, this information may be set to the corresponding handover request identifier value, which was included in the HANDOVER REQUEST message 313 and which uniquely identifies the handover request for the Relay UE;
List of Remote UE Context information. This information indicates the number and/or the identifier of Remote UEs for which the UE context is shared with the target gNB 102.
Remote UE Context Information List information. This information gathers the UE Context Information Information Element (IE), i.e. UE context information which may include the radio resource configuration including local settings not configured across the radio interface, UE capabilities and radio resource management information, as defined in TS 38.423, for each of the Remote UEs that are to perform a handover (HO) to remain connected to the Relay UE 110 when the Relay UE 110 performs a handover (HO) or a conditional handover (CHO).

In addition to the above information, the REMOTE UE CONTEXT TRANSFER message 415, which will be referred to herein as REMOTE UE CONTEXT TRANSFER message 415a for ease of explanation (but the reference 415a is not shown in the figures: only a general REMOTE UE CONTEXT TRANSFER message message 415 is shown in the figures), may also include at least one of the following information, in case such information was not included in the HANDOVER REQUEST message 313, 313a, 313u or 313b previously sent:
List of Bounded Remote UEs information. This information is used to indicate the number and/or the ID of the Remote UEs that have a certain relationship with the Relay UE (e.g. the certain relationship is a strong or close interactive relationship and is based on a relationship which is additional to being wirelessly connected to or served by the Relay UE, such as having applications which interact with applications on the Relay UE). Some Remote UEs may have strong applicative interaction with the Relay UE 110 (e.g. the Remote UE may be a smart watch while the Relay UE may be a smart phone). Thus, such Remote UEs may wish to remain connected to this Relay UE 110 when it performs a handover (HO) or a conditional handover (CHO). Such Remote UEs may be referred to as bounded Remote UEs. In one example, the Relay UE 110 may inform its source gNB 101 about its bounded Remote UEs by sending the list or the number of bounded Remote UEs it is serving in a REMOTE UE INFORMATION message 311.
List of Multipath Remote UEs information. This information is used to indicate the number and/or the ID of the Remote UEs that are also directly connected to the Relay UE. Some Remote UEs may be connected to the Relay UE 110 as part of a multipath connection scheme where each of these Remote UEs also has a direct connection (Uu link) with the source gNB. Such Remote UEs may thus have specific interest in remaining connected to the Relay UE 110 when it performs a handover (HO) or a conditional handover (CHO).
Remote UE Requirements List information. This information gathers, for each for each of the Remote UEs that are to perform a handover (HO) to remain connected to the Relay UE 110 when the Relay UE 110 performs a handover (HO) or a conditional handover (CHO), some specific requirements (e.g. communication requirements) such as QoS requirements (e.g. a minimum QoS level, or a maximum QoS level, or an average QoS level) or some bitrate requirements (e.g. a minimum bitrate, or a maximum bitrate, or average bitrate) or load requirements for the may be provided to the source gNB 101 by the Relay UE 110 using the REMOTE UE INFORMATION message 311.

In one example implementation, the REMOTE UE INFORMATION message 311 used to carry the aforementioned information is the SidelinkUEinformationNR message, defined in 3GPP TS 38.331 v17.1.0.

Upon reception of a REMOTE UE CONTEXT TRANSFER message 415, the target gNB 102 may issue a REMOTE UE CONTEXT TRANSFER ACKNOWLEDGE message 416 to the source gNB 101 to acknowledge the reception of the information included in the REMOTE UE CONTEXT TRANSFER message 415. For example, the REMOTE UE CONTEXT TRANSFER ACKNOWLEDGE message 416 may acknowledge the reception of the Remote UE Context Information List information.

Upon reception of a REMOTE UE CONTEXT TRANSFER message 415 or 415a, the target gNB 102 may issue a REMOTE UE CONTEXT TRANSFER ACKNOWLEDGE message to acknowledge the reception of the information included in the REMOTE UE CONTEXT TRANSFER message 415 or 415a and which REMOTE UE CONTEXT TRANSFER ACKNOWLEDGE message (which will be referred to herein as REMOTE UE CONTEXT TRANSFER ACKNOWLEDGE message 416a for ease of explanation) also includes handover status information related to the UE(s) (i.e. Relay UE and/or all or part of the served Remote UEs) for indicating whether handover (HO or CHO) is accepted. For example, the target gNB 102 may issue a REMOTE UE CONTEXT TRANSFER ACKNOWLEDGE message 416a, to the source gNB 101, to acknowledge the reception of the Remote UE Context Information List information, while including to the REMOTE UE CONTEXT TRANSFER ACKNOWLEDGE message 416a a Handover Granted List information (as discussed above) related to the UE(s) (i.e. Relay UE and all or part of the served Remote UEs) for which the handover or conditional handover is accepted.

This handover status information may indicate whether the HO/CHO for the Relay UE is accepted.

This handover status information may additionally or alternatively include the number and/or the ID of the Remote UEs connected to the Relay UE for which the gNB accepts a HO or a CHO.

In one aspect, the source gNB 101 may request the Relay UE 110 to send a REMOTE UE INFORMATION message 311 by issuing a REMOTE UE INFORMATION REQUEST message 310 to the Relay UE 110 after sending a HANDOVER REQUEST message 313 which does not include context information for the remote UEs (e.g. the HANDOVER REQUEST message is a HANDOVER REQUEST message 313a or HANDOVER REQUEST messages 313u that were previously sent and do not include context information or is a HANDOVER REQUEST message 313b only for the relay UE).

In case the source gNB 101 issued a HANDOVER REQUEST message 313b, which only includes the Sidelink Relay UE Handover information (e.g. a HANDOVER REQUEST message 313b only for the Relay UE 110), the source gNB 101 may, after receiving the HANDOVER REQUEST ACKNOWLEDGE message 314, send remote UE information associated with all or some of the one or more remote UEs served by the Relay UE 110 to the target gNB 102. For example, the source gNB 101 may issue a HANDOVER REQUEST message 515, as depicted in FIG. 5, to negotiate the handover of the Remote UEs served by the Relay UE 110.

In an example of a HANDOVER REQUEST message 515, all or part of the following new Information Elements are added to the existing HANDOVER REQUEST message defined in 3GPP TS 38.423 V17.1.0:
Sidelink Remote UE Handover information. This information is used by the source gNB 101 to indicate to the target gNB 102 that the HO or CHO request is for at least one UE node that is currently acting as a Remote UE served by a Relay UE for which a previous handover was requested.
Related Sidelink Relay UE Handover information. This information allows identifying the Relay UE that is serving the at least one Remote UE for which the Handover request is performed;
List of Remote UEs information. This information is used to indicate the number and/or the ID of the Remote UEs that would remain connected to the Relay UE 110 once it has completed its handover to the target gNB 102. In one example, the List of Remote UEs information refers to all the Remote UEs served by the Relay UE 110. In another example, the List of Remote UEs information refers to the Remote UEs served by the Relay UE that wish to remain connected to the Relay UE 110 once it has completed its handover to the target gNB 102.
List of Bounded Remote UEs information. This information is used to indicate the number and/or the ID of the Remote UEs that have a certain relationship with the Relay UE (e.g. the certain relationship is a strong or close interactive relationship and is based on a relationship which is additional to being wirelessly connected to or served by the Relay UE, such as having applications which interact with applications on the Relay UE). Some Remote UEs may have strong applicative interaction with the Relay UE 110 (e.g. the Remote UE may be a smart watch while the Relay UE may be a smart phone). Thus, such Remote UEs may wish to remain connected to this Relay UE 110 when it performs a handover (HO) or a conditional handover (CHO). Such Remote UEs may be referred to as bounded Remote UEs. In one example, the Relay UE 110 may inform its source gNB 101 about its bounded Remote UEs by sending the list or the number of bounded Remote UEs it is serving in a REMOTE UE INFORMATION message 311.
List of Multipath Remote UEs information. This information is used to indicate the number and/or the ID of the Remote UEs that are also directly connected to the Relay UE. Some Remote UEs may be connected to the Relay UE 110 as part of a multipath connection scheme where each of these Remote UEs also has a direct connection (Uu link) with the source gNB. Such Remote UEs may thus have specific interest in remaining connected to the Relay UE 110 when it performs a handover (HO) or a conditional handover (CHO).
Remote UE Context Information List information. This information gathers the UE Context Information Information Element (IE), i.e. UE context information which may include the radio resource configuration including local settings not configured across the radio interface, UE capabilities and radio resource management information, as defined in TS 38.423, for each of the Remote UEs that are to perform a handover (HO) to remain connected to the Relay UE 110 when the Relay UE 110 performs a handover (HO) or a conditional handover (CHO).

By sharing the Remote UE Context Information List information with the target gNB 102, the source gNB would allow a faster handover of these Remote UEs which would not need to share this information with the target gNB 102 when performing handover and connection reestablishment upon Relay UE 110 handover or conditional handover.
Remote UE Requirements List information. This information gathers, for each for each of the Remote UEs that are to perform a handover (HO) to remain connected to the Relay UE 110 when the Relay UE 110 performs a handover (HO) or a conditional handover (CHO), some specific requirements (e.g. communication requirements) such as QoS requirements (e.g. a minimum QoS level, or a maximum QoS level, or an average QoS level) or some bitrate requirements (e.g. a minimum bitrate, or a maximum bitrate, or average bitrate) or load requirements for the may be provided to the source gNB 101 by the Relay UE 110 using the REMOTE UE INFORMATION message 311.

In an example, after receiving the HANDOVER REQUEST ACKNOWLEDGE message 314 for a HANDOVER REQUEST message 313b only for the Relay UE 110, the source gNB 101 may issue a unitary HANDOVER REQUEST message for each of the Remote UEs it is serving, or for each of the Remote UEs that are to be handed over to remain connected to the Relay UE 110 when the Relay UE 110 performs a handover (HO) or a conditional handover (CHO). Such a HANDOVER REQUEST message will be referred to herein as HANDOVER REQUEST message 515u for ease of explanation but the reference 515u is not shown in the figures: only a general HANDOVER REQUEST message 515 is shown in FIG. 5. Each of these unitary HANDOVER REQUEST messages 515u may include all or part of the information a HANDOVER REQUEST message 515 may include, as previously described.

According to one aspect, in case the source gNB 101 is sending unitary HANDOVER REQUEST messages 515u and the source gNB 101 has sent, in the previous HANDOVER REQUEST message 313 related to Relay UE handover, the number and/or the ID of the Remote UEs list information included in the List of Remote UEs information, the target gNB 102 may rely on the number and/or the ID of the Remote UEs list information included in the List of Remote UEs information sent in the previous HANDOVER REQUEST message 313 related to Relay UE handover, to determine how many unitary HANDOVER REQUEST messages 515u it should receive.

In one aspect, the source gNB 101 may request the Relay UE 110 to send a REMOTE UE INFORMATION message 311 by issuing a REMOTE UE INFORMATION REQUEST message 310 to the Relay UE 110 after receiving the HANDOVER REQUEST ACKNOWLEDGE message 314 for a HANDOVER REQUEST message 313b for the Relay UE 110 and before sending the HANDOVER REQUEST message 515.

In one example, context information for the remote UEs may not be included in the HANDOVER REQUEST message 515: for example, when the Remote UE Context Information List information may not be included in the HANDOVER REQUEST message 515, which will be referred to herein as HANDOVER REQUEST message 515a for ease of explanation but which is not shown in FIG. 5 which only shows a general HANDOVER REQUEST message 515.

According to another example, only information for handover of the relay UE, such as only the Sidelink Remote UE Handover information, may be included in the HANDOVER REQUEST message 515, which will be referred to herein as HANDOVER REQUEST message 515b for ease of explanation. In both cases, the HANDOVER REQUEST message 515a or 515b only aim at requesting the handover for all or part of the Remote UEs served by the Relay UE 110 without providing any context information for the Remote UEs.

Based on the information received from the source gNB 101 in the HANDOVER REQUEST message 515, the target gNB 102 may perform some Admission Control (at 319), in order to determine whether the handover of all or part of the Remote UEs considered in HANDOVER REQUEST message 515 (or its variants 515a or 515b) can be accepted.

The target gNB 102 then prepares the handover for all or part of said Remote UEs and sends to the source gNB 101 the HANDOVER REQUEST ACKNOWLEDGE message 516, which includes a transparent container to be sent to the considered UE(s) as an RRC message to perform the handover. In one example, the HANDOVER REQUEST ACKNOWLEDGE message 516 may include handover status information such as a Handover Granted List information related to the Remote UEs for which the handover is accepted.

This information may include the number and/or the ID of the Remote UEs connected to the Relay UE for which the gNB accepts a HO.

In case the target gNB 102 included the Handover Granted List information in the HANDOVER REQUEST ACKNOWLEDGE message 516, the source gNB 101 may then inform the Relay UE 110 about the Remote UEs that have been allowed by the target gNB 102 to be handed over to it, using the REMOTE UE INFORMATION RESPONSE message 317. Based on the Remote UEs handover status included in the REMOTE UE INFORMATION RESPONSE message 317, the Relay UE 110 may in turn notify its served UEs (e.g. Remote UE 111, Remote UE 112) so that they may adjust their connectivity with the Relay UE 110. For example, a Remote UE which would not be allowed to perform handover from the source gNB 101 to the target gNB 102 may decide to detach from the Relay UE 110 and perform relay reselection to identify a different Relay UE to connect with.

In one example, in case the source gNB 101 issued unitary HANDOVER REQUEST messages 515u for each Remote UE, the target gNB 102 may respond by sending, for each of the received unitary HANDOVER REQUEST messages 515u, a unitary HANDOVER ACKNOWLEDGE message (referred to herein as HANDOVER ACKNOWLEDGE message 516u for ease of explanation but which reference is not shown in FIG. 5 which only shows a general HANDOVER ACKNOWLEDGE message 516), which indicates if the handing over of the corresponding Remote UE is accepted or not.

In case the source gNB 101 did not include the Remote UE Context Information List information in the HANDOVER REQUEST message 515, the target gNB 102 may initiate a Retrieve UE Context procedure to retrieve the UE context of the Remote UEs that are allowed to perform a handover along with the Relay UE 110.

The target gNB 102 initiates this procedure by sending a REMOTE UE CONTEXT INFO REQUEST message 517 (similar to message 315 shown in and described with respect to FIG. 3) to the source gNB 101. In one example, the REMOTE UE CONTEXT INFO REQUEST message 517 is the RETRIEVE UE CONTEXT REQUEST message defined in 3GPP TS 38.423 V17.1.0.

According to one aspect, the REMOTE UE CONTEXT INFO REQUEST message 517 may include all or part of the following information:
Related Sidelink Relay UE Handover information. This information allows identifying the Relay UE that is serving the Remote UEs for which the UE context is requested by the target gNB 102;
List of Requested Remote UE Context information. This information indicates the number and/or the identifier of Remote UEs for which the UE context is requested by the target gNB 102.

In an example, the target gNB 102 may issue a unitary REMOTE UE CONTEXT INFO REQUEST message (referred to as message 517u for ease of explanation) for each of the Remote UEs for which a HANDOVER REQUEST message 515 or a unitary HANDOVER REQUEST 515u was received.

Upon reception of the REMOTE UE CONTEXT INFO REQUEST message 517, the source gNB 101 may send back to the target gNB 102 a REMOTE UE CONTEXT INFO RESPONSE message 518 (similar to message 316 shown in and described with respect to FIG. 3) which may include the Remote UE Context Information List information, as previously defined for the HANDOVER REQUEST message 313 and 515. According to one aspect, the REMOTE UE CONTEXT INFO RESPONSE message 518 may be the RETRIEVE UE CONTEXT RESPONSE message defined in 3GPP TS 38.423 V17.1.0.

In one example, the source gNB 101 may issue a unitary REMOTE UE CONTEXT INFO RESPONSE message (referred to as message 518u for ease of explanation) for each of the Remote UEs for which a REMOTE UE CONTEXT INFO REQUEST message 517 or a unitary REMOTE UE CONTEXT INFO REQUEST 517u was received.

Examples of processes for managing Relay UE legacy handover (HO) or Relay UE conditional handover (CHO) will now be described according to some embodiments of the present invention.

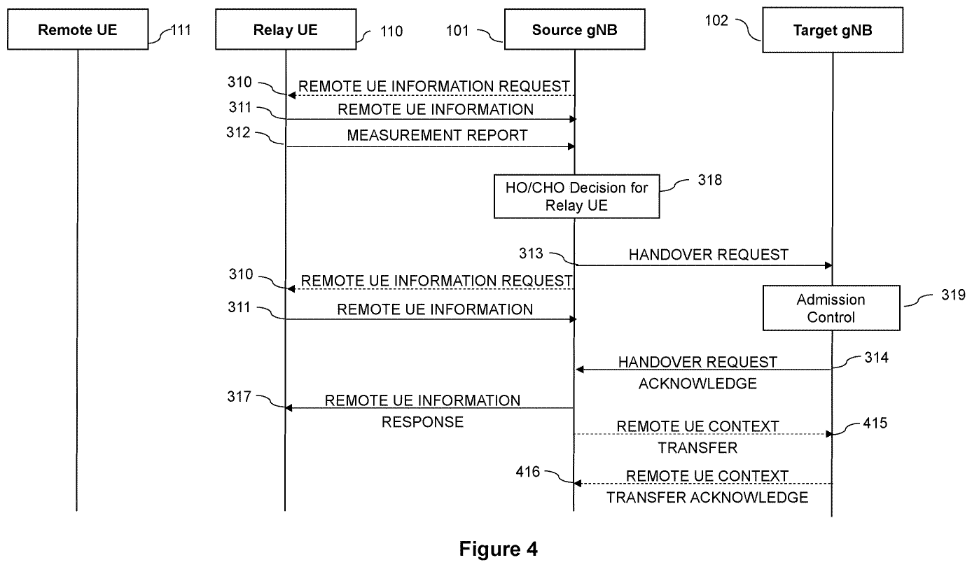

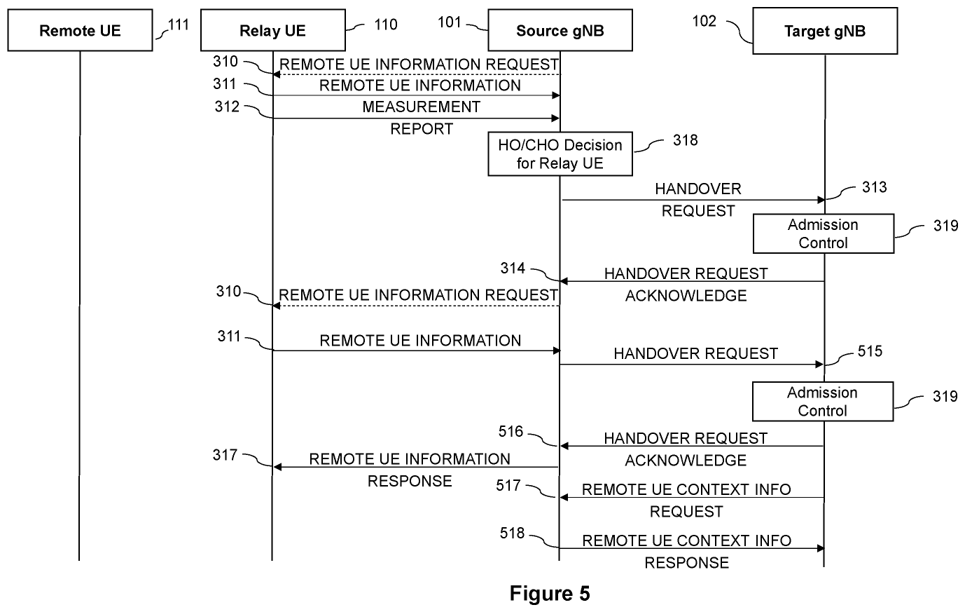

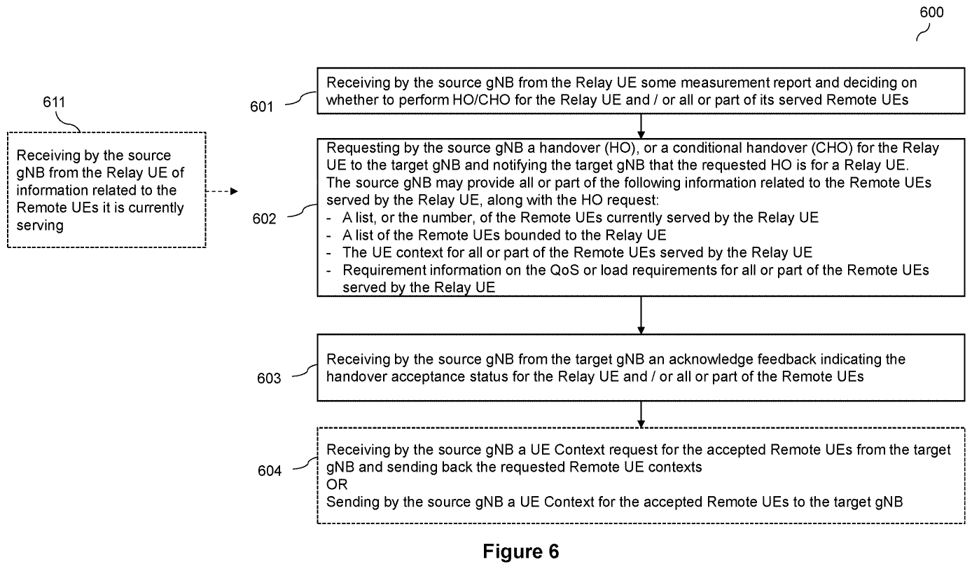

FIG. 6 shows steps of an example method 600 for use in a process of handover (e.g. handover (HO) initiated by the source base station (legacy handover) or conditional handover (CHO) initiated by the relay UE) management for a Relay UE and its served Remote UEs, in accordance with embodiments of the present invention.

The considered Relay UE is serving a plurality of Remote UEs and is connected to a source gNB.

The method 600 of FIG. 6 is performed at the source gNB. For example, with reference to the wireless communication system shown in and described with respect to FIG. 1, the source gNB performing the method 600 may be the source gNB 101, the target gNB may be the target gNB 102 and the Relay UE may be the Relay UE 110 serving one or more Remote UEs, such as Remote UEs 111 and 112.

The method 600 as shown in and described with respect to FIG. 6 may be performed by software elements and/or hardware elements. Thus, for example, the method as shown in and described with respect to FIG. 6 may be performed by an apparatus for the source gNB comprising one or more processing units configured to carry out the method. The source gNB may be implemented in a communication device 1000 as shown in and described with reference to FIG. 10 with the method as shown in and described with respect to FIG. 6 being performed by one or more processing units, such as the central processing unit 1011.

In step 601, the source gNB 101 may receive some measurement reporting, such as the MEASUREMENT REPORT 312, from the Relay UE 110 and, based on the received measurement values, the source gNB 101 may decide to initiate a handover (HO) procedure in order for the Relay UE 110 to connect to the target gNB 102. For instance, if the quality of the signal between the Relay UE 110 and the target gNB 102 is significantly better than the quality of the signal between the Relay UE and the target gNB 102, the source gNB 101 may decide to initiate a handover process for the Relay UE 110 and/or all or some (or part) of the served Remote UEs 111 and/or 112.

Alternatively, based on these measurement reporting 312, the source gNB 101 may allow the Relay UE 110 to decide whether or not to perform handover from source gNB 101 to target gNB 102 provided that some specific conditions are met. This procedure where the handover is executed by the Relay UE when it evaluates that one or more handover execution conditions, configured by the source gNB 101, are met is referred to as a Conditional Handover (CHO) process. For instance, based on the evaluation of the quality of the signal between the Relay UE and the target gNB 102, the source gNB 101 may estimate that some handover of the Relay UE 110 from the source gNB 101 to the target gNB 102 is likely to happen in the future. Therefore, the source gNB 101 will define some conditional handover configuration, which includes one or more handover execution conditions that must be met before a handover can executed by the UE, for the Relay UE 110 and will initiate a conditional handover process with the target gNB 102. More details of CHO are set out in clause 9.2.3.4 of 3GPP TS 38-300 v17.1.0. Although the Figures only show messages exchanged between the source gNB and a target gNB, for CHO there may be more than one candidate target gNB (the relay UE selects one of the candidate target gNBs as the target gNB when the handover execution conditions are met for at least one of the candidate target gNBs) and so the messages (e.g. the handover request and the remote UE information) may be exchanged between the source gNB 101 and each of the candidate target gNBs (i.e. to more than one target gNB).

Thus, for either HO or CHO, the source gNB 101, based on received measurement report(s), decides, in step 601, whether to perform handover (HO or CHO) for the Relay UE 110 and/or all or some (or part) of the served Remote UEs 111 and/or 112.

In step 602, based on the decision resulting from step 601, the source gNB 101 may request a handover (HO), or a conditional handover (CHO), for the Relay UE 110 to the target gNB 102 and notifies the target gNB 102 that the requested HO is for a Relay UE. The source gNB will do this by sending to the target gNB 102 a handover request for the Relay UE. For example, by sending a HANDOVER REQUEST message for the Relay UE such as message 313 (313a, 313b) as defined in and described with respect to FIGS. 3 and 4.

As discussed above with respect to the HANDOVER REQUEST message 313, 313a, 313b, the source gNB may include at least one of: Sidelink Relay UE Handover information, indicating to the target gNB 102 that the HO or CHO request is for a UE node that is currently acting as a Relay UE (i.e. Relay UE 110) serving one or more Remote UEs; a list of Remote UEs to be handed over, which indicates the number and/or the ID of the Remote UEs that would remain connected to the Relay UE 110 once it has completed its handover to the target gNB 102; a list of Bounded Remote UEs, i.e. Remote UEs having strong applicative interaction with the Relay UE 110 and that may wish to remain connected to this Relay UE 110 when it performs a handover (HO) or a conditional handover (CHO); a list of Multipath Remote UEs, i.e. Remote UEs that are connected to the Relay UE 110 as part of a multipath connection scheme where each of these Remote UEs also has a direct connection (Uu link) with the source gNB 101; a Remote UE Context Information List, which gathers the UE Context Information—i.e. UE context information which may include the radio resource configuration including local settings not configured across the radio interface, UE capabilities and radio resource management information, as defined in TS 38.423—for each of the Remote UEs that are to perform a handover (HO) in order to remain connected to the Relay UE 110 when the Relay UE 110 performs a handover (HO) or a conditional handover (CHO); a list of Remote UE requirements, which gathers, for each of the Remote UEs that are to perform a handover (HO) to remain connected to the Relay UE 110 when the Relay UE 110 performs a handover (HO) or a conditional handover (CHO), some specific requirements (e.g. communication requirements) such as QoS requirements (e.g. a minimum QoS level, or a maximum QoS level, or an average QoS level) or some bitrate requirements (e.g. a minimum bitrate, or a maximum bitrate, or average bitrate) or load requirements for the considered Remote UE.

In order to determine the list of Remote UEs to be handed over and/or the list of Bounded Remote UEs and/or the list of Multipath Remote UEs and/or the list of Remote UE requirements, the source gNB 101 may rely on some information previously received from the Relay UE 110, via the REMOTE UE INFORMATION message 311, during step 611. This step 611 may preferably happen before step 601 or between step 601 and step 602, in order for the source gNB 101 to have a maximum of information to pass to the target gNB 102 through the HANDOVER REQUEST message.

In one aspect, the source gNB 101 may request the Relay UE 110 to send a REMOTE UE INFORMATION message 311 by issuing a REMOTE UE INFORMATION REQUEST message 310 to the Relay UE 110.

In one aspect, in case the source gNB 101 does not have sufficient information on the Remote UEs served by the Relay UE 110 that wish to remain connected to the Relay UE 110 once it has completed its handover to the target gNB 102, for instance because it did not receive any REMOTE UE INFORMATION message 311, the source gNB 101 may fill the list of Remote UEs to be handed over with the Identifiers of all the Remote UEs currently served by the Relay UE 110.

In one aspect, in case the source gNB 101 does not have sufficient information on the Remote UEs served by the Relay UE that wish to remain connected to the Relay UE 110 once it has completed its handover to the target gNB 102, the source gNB 101 may request the Relay UE 110 to send a REMOTE UE INFORMATION message 311 by issuing a REMOTE UE INFORMATION REQUEST message 310 to the Relay UE 110 as described above with respect to FIGS. 3 to 5.

In step 603, the source gNB 101 may receive from the target gNB 102 handover status information indicating handover granted (or acceptance) status for the Relay UE 110 and/or all or some of the Remote UEs wirelessly connected to or served by the Relay UE 110. For example, the source gNB 101 may receive from the target gNB 102 an acknowledge feedback, via the HANDOVER REQUEST ACKNOWLEDGE message 314, as discussed in FIG. 3, indicating the handover acceptance status for the Relay UE and/or all or part of the Remote UEs served by the Relay UE 110 for which a handover was requested.

In one example, in case the source gNB 101 issued unitary HANDOVER REQUEST messages 313u to the target gNB 102 for each of the Remote UEs the Relay UE 110 is serving, or for each of the Remote UEs that are to be handed over to remain connected to the Relay UE 110 as discussed above, the target gNB 102 may respond, in step 603, by sending, for each of the received unitary HANDOVER REQUEST messages 313u, a unitary HANDOVER ACKNOWLEDGE message 314u which indicates if the handing over of the corresponding Remote UE is accepted or not.

In case a context information for the Remote UEs served by the Relay UE 110 was included in the HANDOVER REQUEST message sent by the source gNB 101 at step 602 (for example, a Remote UE Context Information list was included in the HANDOVER REQUEST message issued at step 602 by the source gNB 101), the method described in procedure 600 may end at step 603.

In case context information (e.g. a Remote UE Context Information List) was not included in the HANDOVER REQUEST message issued or sent at step 602 by the source gNB 101, the source gNB may receive in step 604, according to one example, a UE context request for each of the Remote UEs for which a handover was accepted at step 603 by the target gNB 102, using the REMOTE UE CONTEXT INFO REQUEST message 315, as shown in and discussed with respect to FIG. 3. The source gNB 101 may in turn send back the requested Remote UE contexts to the target gNB 102 via the REMOTE UE CONTEXT INFO RESPONSE message 316.

According to another example, in case context information (e.g. a Remote UE Context Information List) was not included in the HANDOVER REQUEST message issued or sent at step 602 by the source gNB 101, the source gNB may send, in step 604, a UE context for each of the Remote UEs for which a handover was accepted at step 603 by the target gNB 102, using the REMOTE UE CONTEXT TRANSFER message 415, as shown in and discussed with respect to FIG. 4. The source gNB 102 may further receive an acknowledgement of the reception of the requested Remote UE contexts from the target gNB 102 via the REMOTE UE CONTEXT TRANSFER ACKNOWLEDGE message 416.

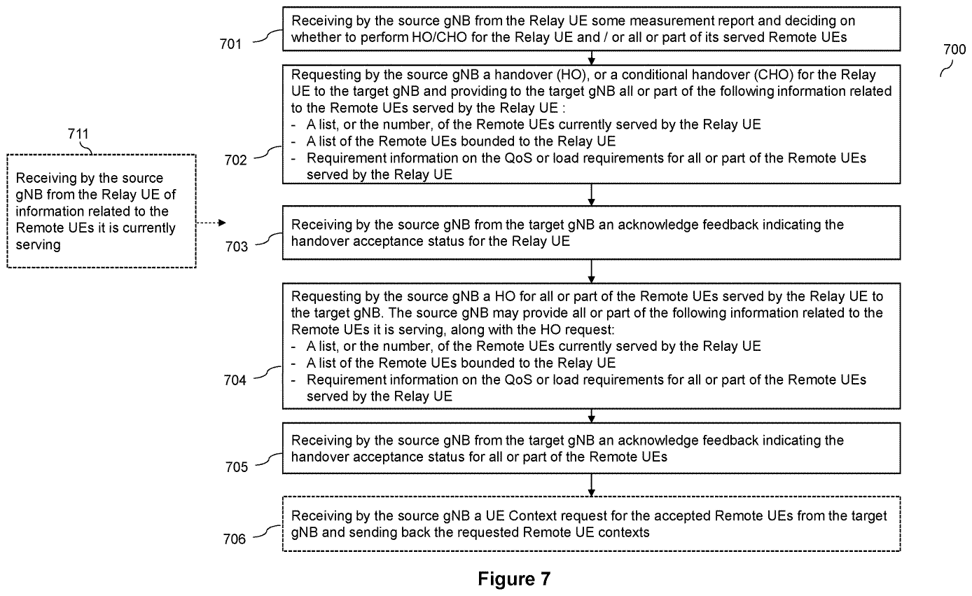

FIG. 7 shows steps of an example method 700 for use in a process of handover (e.g. handover (HO) initiated by the source base station (legacy handover) or conditional handover (CHO) initiated by the relay UE) management for a Relay UE and its served Remote UEs, in accordance with embodiments of the present invention.

The considered Relay UE is serving a plurality of Remote UEs and is connected to a source gNB.

The method 700 of FIG. 7 is performed at the source gNB. For example, with reference to the wireless communication system shown in and described with respect to FIG. 1, the source gNB performing the method 700 may be the source gNB 101, the target gNB may be the target gNB 102 and the Relay UE may be the Relay UE 110 serving one or more Remote UEs, such as Remote UEs 111 and 112.

The method 700 as shown in and described with respect to FIG. 7 may be performed by software elements and/or hardware elements. Thus, for example, the method as shown in and described with respect to FIG. 7 may be performed by an apparatus for the source gNB comprising one or more processing units configured to carry out the method. The source gNB may be implemented in a communication device 1000 as shown in and described with reference to FIG. 10 with the method as shown in and described with respect to FIG. 7 being performed by one or more processing units, such as the central processing unit 1011.

In step 701, the source gNB 101 may receive some measurement reporting, such as the MEASUREMENT REPORT 312, from the Relay UE 110 and, based on the received measurement values, the source gNB may decide to initiate a handover (HO) procedure in order for the Relay UE 110 to connect to the target gNB 102. For instance, if the quality of the signal between the Relay UE 110 and the target gNB 102 is significantly better than the quality of the signal between the Relay UE and the source gNB 101, the source gNB 101 may decide to initiate a handover process for the Relay UE 110 and/or all or some (or part) of the served Remote UEs 111 and/or 112.

Alternatively, based on these measurement reporting 312, the source gNB 101 may allow the Relay UE 110 to decide whether or not to perform handover from source gNB 101 to target gNB 102 provided that some specific conditions are met. This procedure where the handover is executed by the Relay UE when it evaluates that one or more handover execution conditions, configured by the source gNB 101, are met is referred to as a Conditional Handover (CHO) process. For instance, based on the evaluation of the quality of the signal between the Relay UE and the target gNB 102, the source gNB 101 may estimate that some handover of the Relay UE 110 from the source gNB 101 to the target gNB 102 is likely to happen in the future. Therefore, the source gNB 101 will define some conditional handover configuration, which includes one or more handover execution conditions that must be met before a handover can be executed by the UE, for the Relay UE 110 and will initiate a conditional handover process with the target gNB 102. More details of CHO are set out in clause 9.2.3.4 of 3GPP TS 38-300 v 17.1.0. As mentioned above, for CHO there may be more than one candidate target gNB and so the messages (e.g. the handover request and the remote UE information) may be exchanged between the source gNB 101 and each of the candidate target gNBs (i.e. to more than one target gNB).

Thus, for either HO or CHO, the source gNB 101, based on received measurement report(s), decides, in step 701, whether to perform handover (HO or CHO) for the Relay UE 110 and/or all or some (or part) of the served Remote UEs 111 and/or 112.

In step 702, based on the decision resulting from step 701, the source gNB 101 may request a handover (HO), or a conditional handover (CHO), for the Relay UE 110 to the target gNB 102 and notifies the target gNB 102 that the requested HO is for a Relay UE. The source gNB will do this by sending to the target gNB 102 a handover request for the Relay UE. For example, by sending a HANDOVER REQUEST message 313 (313a, 313b) as defined in and described with respect to FIGS. 3, 4 and 5.

As discussed above with respect to the HANDOVER REQUEST message 313, 313a, 313b, the source gNB may include at least one of: Sidelink Relay UE Handover information, indicating to the target gNB 102 that the HO or CHO request is for a UE node that is currently acting as a Relay UE (i.e. Relay UE 110) serving one or more Remote UEs; a list of Remote UEs to be handed over, which indicates the number and/or the ID of the Remote UEs that would remain connected to the Relay UE 110 once it has completed its handover to the target gNB 102; a list of Bounded Remote UEs, i.e. Remote UEs having strong applicative interaction with the Relay UE 110 and that may wish to remain connected to this Relay UE 110 when it performs a handover (HO) or a conditional handover (CHO); a list of Multipath Remote UEs, i.e. Remote UEs that are connected to the Relay UE 110 as part of a multipath connection scheme where each of these Remote UEs also has a direct connection (Uu link) with the source gNB 101; a list of Remote UE requirements, which gathers, for each of the Remote UEs that are to perform a handover (HO) to remain connected to the Relay UE 110 when the Relay UE 110 performs a handover (HO) or a conditional handover (CHO), some specific requirements (e.g. communication requirements) such as QoS requirements (e.g. a minimum QoS level, or a maximum QoS level, or an average QoS level) or some bitrate requirements (e.g. a minimum bitrate, or a maximum bitrate, or average bitrate) or load requirements for the considered Remote UE.

In one aspect, only the Sidelink Relay UE Handover information is included in the HANDOVER REQUEST message indicating that the HO or CHO request is for a Relay UE.

In such a case, in order to determine the list of Remote UEs to be handed over and/or the list of Bounded Remote UEs and/or the list of Multipath Remote UEs and/or the list of Remote UE requirements, the source gNB 101 may rely on some information previously received from the Relay UE 110, via the REMOTE UE INFORMATION message 311 (discussed above with reference to FIGS. 3 to 5), during step 711. This step 711 may preferably happen before any one of steps 701, 702, 703 or 704, in order for the source gNB to have a maximum of information to pass to the target gNB 102 through the HANDOVER REQUEST message.

In one aspect, the source gNB 101 may request the Relay UE 110 to send a REMOTE UE INFORMATION message 311 by issuing a REMOTE UE INFORMATION REQUEST message 310 to the Relay UE 110 as discussed above.

In one aspect, in case the source gNB 101 does not have sufficient information on the Remote UEs served by the Relay UE 110 that wish to remain connected to the Relay UE 110 once it has completed its handover to the target gNB 102, for instance because it did not receive any REMOTE UE INFORMATION message 311, the source gNB 101 may fill the list of Remote UEs to be handed over with the Identifiers of all the Remote UEs currently served by the Relay UE 110.

In step 703, the source gNB 101 may receive from the target gNB 102 handover status information indicating handover granted (or acceptance) status for the Relay UE 110. For example, the source gNB 101 may receive from the target gNB 102 an acknowledge feedback, via the HANDOVER REQUEST ACKNOWLEDGE message 314, as discussed in FIG. 3, indicating the handover acceptance status for the Relay UE 110.

In step 704, the source gNB 101 may request a handover (HO) to the target gNB 102 for the all or part (or some) of the Remote UEs served by the Relay UE 110 which handover was accepted at step 703. The source gNB will do this by sending to the target gNB 102 remote UE information associated with all or some of the Remote UEs served by the Relay UE 110 included in at least one additional message for all or part of the Remote UEs served by the Relay UE 110. For example, the at least one additional message may be a HANDOVER REQUEST message 515 or the HANDOVER REQUEST messages 515u as described with reference to FIG. 5.

The source gNB 101 may include, in the HANDOVER REQUEST message 515, at least one of: Sidelink Remote UE Handover information, indicating to the target gNB 102 that the HO request is for a for a UE node that is currently acting as a Remote UE served by a Relay UE for which a previous handover was requested (i.e. Relay UE 110); a related Sidelink Relay UE Handover information, which identifies the Relay UE that is serving the Remote UEs for which the Handover request is performed; a list of Remote UEs to be handed over, which indicates the number and/or the ID of the Remote UEs that would remain connected to the Relay UE 110 once it has completed its handover to the target gNB 102; a list of Bounded Remote UEs, i.e. Remote UEs having strong applicative interaction with the Relay UE 110 and that may wish to remain connected to this Relay UE 110 when it performs a handover (HO) or a conditional handover (CHO); a list of Multipath Remote UEs, i.e. Remote UEs that are connected to the Relay UE 110 as part of a multipath connection scheme where each of these Remote UEs also has a direct connection (Uu link) with the source gNB 101; a Remote UE Context Information List, which gathers the UE Context Information—i.e. UE context information which may include the radio resource configuration including local settings not configured across the radio interface, UE capabilities and radio resource management information, as defined in TS 38.423—for each of the Remote UEs that are to perform a handover (HO) in order to remain connected to the Relay UE 110 when the Relay UE 110 performs a handover (HO) or a conditional handover (CHO); a list of Remote UE requirements, which gathers, for each of the Remote UEs that are to perform a handover (HO) to remain connected to the Relay UE 110 when the Relay UE 110 performs a handover (HO) or a conditional handover (CHO), some specific requirements (e.g. communication requirements) such as QoS requirements (e.g. a minimum QoS level, or a maximum QoS level, or an average QoS level) or some bitrate requirements (e.g. a minimum bitrate, a maximum bitrate, or average bitrate) or load requirements for the considered Remote UE.

In step 705, the source gNB 101 may receive from the target gNB 102 handover status information indicating handover granted (or acceptance) status for the Remote UEs. For example, the source gNB 101 may receive from the target gNB 102 an acknowledge feedback, via the HANDOVER REQUEST ACKNOWLEDGE message 516, as discussed with reference to FIG. 5, indicating the handover acceptance status for the Remote UEs for which the handover was requested.

In one example, in case the source gNB 101 issued unitary HANDOVER REQUEST messages 515u for each Remote UE as discussed above with reference to FIG. 5, the target gNB 102 may respond by sending, for each of the received unitary HANDOVER REQUEST messages 515u, a unitary HANDOVER ACKNOWLEDGE message 516u which indicates if the handing over of the corresponding Remote UE is accepted or not.

In case a Remote UE Context Information list was included in the HANDOVER REQUEST message issued at step 704 by the source gNB 101, the method described in procedure 700 may end at step 705.

In case context information for the Remote UEs (e.g. a Remote UE Context Information List) was not included in the HANDOVER REQUEST message issued or sent at step 704 by the source gNB 101, the source gNB may receive in step 706, according to an example, a UE context request for each of the Remote UEs for which a handover was accepted at step 705 by the target gNB 102, using the REMOTE UE CONTEXT INFO REQUEST message 517, as discussed with respect to FIG. 5. The source gNB 101 may in turn send back the requested Remote UE contexts to the target gNB 102 via the REMOTE UE CONTEXT INFO REQUEST message 518.

FIG. 8 shows steps of an example method 800 for use in a process of handover (e.g. handover (HO) initiated by the source base station (legacy handover) or conditional handover (CHO) initiated by the relay UE) management for a Relay UE and its served Remote UEs, in accordance with embodiments of the present invention.

The considered Relay UE is serving a plurality of Remote UEs and is connected to a source gNB.

The method 800 of FIG. 8 is performed at the target gNB. For example, with reference to the wireless communication system shown in and described with respect to FIG. 1, the target gNB performing the method 800 may be the target gNB 102, the source gNB may be the source gNB 101 and the Relay UE may be the Relay UE 110 serving one or more Remote UEs, such as Remote UEs 111 and 112.

The method 800 as shown in and described with respect to FIG. 8 may be performed by software elements and/or hardware elements. Thus, for example, the method as shown in and described with respect to FIG. 8 may be performed by an apparatus for the target gNB comprising one or more processing units configured to carry out the method. The target gNB may be implemented in a communication device 1000 as shown in and described with reference to FIG. 10 with the method as shown in and described with respect to FIG. 8 being performed by one or more processing units, such as the central processing unit 1011.

In step 801, the target gNB 102 may receive from the source gNB 101 a handover request for the Relay UE 110, which may be a handover (HO) request, or a conditional handover (CHO) request, for the Relay UE 110. The handover request may be included in a HANDOVER REQUEST message 313 received from the source gNB 101 which may include remote UE information associated with all or some (or part) of the Remote UEs served by the Relay UE 110 (e.g. information related to all or part of the Remote UEs that are served by the Relay UE 110), as described with reference to FIGS. 3, 4 and 6.

Then, in step 802, the target gNB 102 may perform an Admission Control process for the requested Relay UE 110 and/or all or part of the Remote UEs served by this Relay UE based on the information included in the handover request (e.g. HANDOVER REQUEST message) received from source gNB 101 in step 801. See also the description of the Admission Control 319 above.

The knowledge gained by the target Remote UE 102 from all or part of the Sidelink Relay UE Handover information, the list of Remote UEs information, the list of Bounded Remote UEs information, the list of Multipath Remote UEs information, the Remote UE Context Information list and Remote UE Requirements list, when included in a handover request message, allows the target Remote UE 102 to process the admission control in step 802 in a more efficient way.

For instance, having the knowledge of the number of Remote UEs served by the Relay UE 110 and/or the knowledge of the requirements (e.g. bitrate, QoS . . . ) of each of these Remote UEs may allow the target gNB to better evaluate the potential impact of these remote UEs on the performance of the network cell managed by the target gNB 102 if the Remote UEs were to join this cell.

According to one aspect, the target gNB 102 may give precedence for handover acceptance to the Bounded Remote UEs or to the Remote UEs having some multipath connectivity that involves the Relay UE 110 or to the Remote UEs that have less impact on the performance of the cell controlled by the target gNB 102.

The target gNB 102 may then send handover status information indicating handover granted (or acceptance) status for the Relay UE 110 and/or all or part of the Remote UEs.

For example, the source gNB 101 may receive from the target gNB 102 an acknowledge feedback, such as the HANDOVER REQUEST ACKNOWLEDGE message 314 discussed with respect to FIG. 3, to the source gNB 101 indicating the handover acceptance status for the Relay UE 110 and/or all or part of the Remote UEs.

In case context information for the Remote UEs served by the Relay UE 110 (e.g. a Remote UE Context Information list) was included in the HANDOVER REQUEST message received at step 801 by the target gNB 102, the method described in procedure 800 may end at step 802.

According to one aspect, in case context information (e.g. a Remote UE Context Information list) was not included in the HANDOVER REQUEST message received at step 801, the target gNB 102 may request to the source gNB 101, in step 803, a UE Context for the Remote UEs which handover was accepted at step 802, by issuing a REMOTE UE CONTEXT INFO REQUEST message 315, as discussed in relation with FIG. 3. The target gNB 102 may then wait for the reception of the requested Remote UE contexts from the source gNB 101, via the REMOTE UE CONTEXT INFO RESPONSE message 316.

According to another aspect, in case context information (e.g. a Remote UE Context Information list) was not included in the HANDOVER REQUEST message received at step 801, the target gNB 102 may receive from the source gNB 101, in step 803, a UE Context for the Remote UEs which handover was accepted at step 802, via the REMOTE UE CONTEXT TRANSFER message 415, as discussed in relation with FIG. 4. The target gNB 102 may then confirm the reception of the Remote UE contexts to the source gNB 101, via the REMOTE UE CONTEXT TRANSFER ACKNOWLEDGE message 416.

By providing context information for the Remote UEs to the target gNB prior to when handover of the Remote UEs is executed (e.g. providing context information as part of managing handover of the Relay UE 110 or when negotiating handover of the Relay UE between the source gNB and target gNB), executing handover of the Remote UEs to the target gNB 102, when the Relay UE 110 is handed over to the target gNB 102, is faster and more efficient.

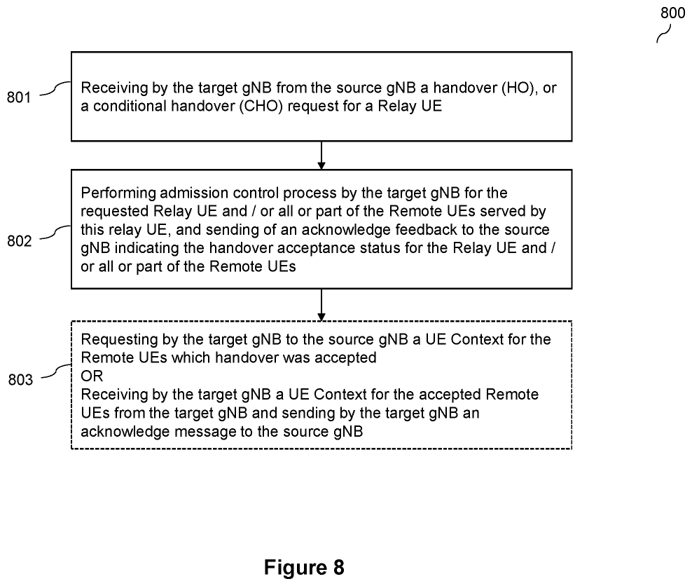

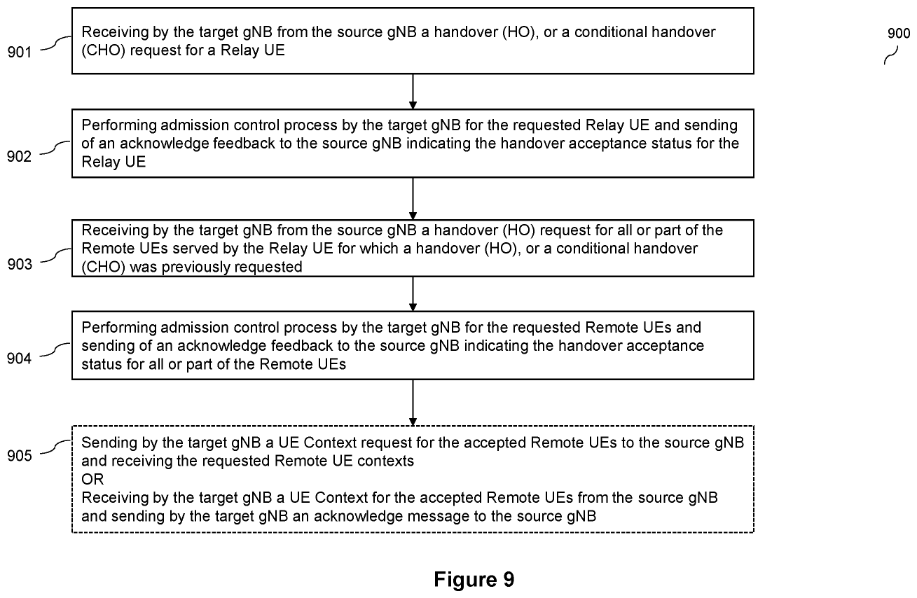

FIG. 9 shows steps of an example method 900 for use in a process of handover (e.g. handover (HO) initiated by the source base station (legacy handover) or conditional handover (CHO) initiated by the relay UE) management for a Relay UE and its served Remote UEs, in accordance with embodiments of the present invention.

The considered Relay UE is serving a plurality of Remote UEs and is connected to a source gNB.

The method 900 of FIG. 9 is performed at the target gNB. For example, with reference to the wireless communication system shown in and described with respect to FIG. 1, the target gNB performing the method 900 may be the target gNB 102, the source gNB may be the source gNB 101 and the Relay UE may be the Relay UE 110 serving one or more Remote UEs, such as Remote UEs 111 and 112.

The method 900 as shown in and described with respect to FIG. 9 may be performed by software elements and/or hardware elements. Thus, for example, the method as shown in and described with respect to FIG. 9 may be performed by an apparatus for the target gNB comprising one or more processing units configured to carry out the method. The target gNB may be implemented in a communication device 1000 as shown in and described with reference to FIG. 10 with the method as shown in and described with respect to FIG. 9 being performed by one or more processing units, such as the central processing unit 1011.

In step 901, the target gNB 102 may receive from the source gNB 101 a handover request for the Relay UE 110, which may be a handover (HO) request, or a conditional handover (CHO) request for the Relay UE 110. The handover request may be included in a HANDOVER REQUEST message 313 received from the source gNB 101 which may include information indicated that this handover request is for a UE acting as a Relay UE (i.e. Relay UE 110) which may be serving one or more Remote UEs, as described with respect to FIGS. 5 and 7.

Then, in step 902, the target gNB 102 may perform an Admission Control process for the requested Relay UE 110 based on the information included in the handover request (e.g. HANDOVER REQUEST message) received from source gNB 101 in step 901. See also the description of the Admission Control 319 above.

Having the knowledge that the handover request is for a Relay UE node may allow the target Remote UE 102 to process the admission control in step 902 in a more efficient way.

For instance, in case the cell managed by the target gNB 102 has almost reached its full capacity due to serving a significant number of UEs, the target gNB 102 may reject the handover request for a Relay UE node as this may imply some potential handover of all or part of the Remote UEs served by this Relay UE.

The target gNB 102 may then send, to the source gNB 101, handover status information indicating handover granted (or acceptance) status for the Relay UE 110 and/or all or part of the Remote UEs. For example, the target gNB 102 may send an acknowledge feedback, such as the HANDOVER REQUEST ACKNOWLEDGE message 314 discussed in FIG. 3, to the source gNB 101 indicating the handover acceptance status for the Relay UE 110.

In step 903, the target gNB 102 may receive from the source gNB 101 a handover request (e.g. HO request) for all or part of the Remote UEs served by the Relay UE 110. The handover request for all or part of the Remote UEs may be included in a HANDOVER REQUEST message 515, as discussed with respect to FIG. 5, received from the source gNB 101 and which may include remote UE information associated with all or some (or part) of the Remote UEs served by the Relay UE 110 (e.g. information related to all or part of the Remote UEs that are served by the Relay UE 110, as described with respect to FIGS. 5 and 7.

The remote UE information associated with all or some (or part) of the one or more Remote UEs served by the Relay UE may include remote UE quantity information for indicating a quantity of resource required at the target gNB for the remote UEs which would remain connected to the relay UE after the relay UE completes handover (which could be all or some of the remote UEs served by the relay UE) and/or context information for each of the all or some of the one or more Remote UEs served by the Relay UE. The remote UE quantity information may include one or more of the List of Remote UEs information, List of Bounded Remote UEs information, List of Multipath Remote UEs information as discussed above. The context information may include Remote UE Context Information List information as discussed above. The remote UE information may include remote UE requirement information (e.g. Remote UE Requirements List information) for indicating communication requirements for each of the all or some of the one or more Remote UEs served by the Relay UE as discussed above.

Then, in step 904, the target gNB 102 may perform an Admission Control process for the requested Remote UEs based on the information included in the handover request message received from source gNB 101 in step 903. See also the description of the Admission Control 319 above.

The knowledge gained by the target Remote UE 102 from all or part of the list of Remote UEs, the list of Bounded Remote UEs information, the list of Multipath Remote UEs information, the Remote UE Context Information list information and Remote UE Requirements list, when included in a handover request message, allows the target gNB 102 to process the Admission Control in step 904 in a more efficient way.

For instance, having the knowledge of the number of Remote UEs served by the Relay UE 110 and/or the knowledge of the requirements (e.g. bitrate, QoS . . . ) of each of these Remote UEs may allow the target gNB to better evaluate the potential impact of these remote UEs on the performance of the network cell managed by the target gNB 102 if the Remote UEs were to join this cell.

According to one aspect, the target gNB 102 may give precedence for handover acceptance to the Bounded Remote UEs or the Remote UEs having some multipath connectivity that involves the Relay UE 110 or to the Remote UEs that have less impact on the performance of the cell controlled by the target gNB 102.

The target gNB 102 may then send, to the source gNB 101, handover status information indicating handover granted (or acceptance) status for the all or part of the Remote UEs. For example, the target gNB 102 may send an acknowledge feedback, such as the HANDOVER REQUEST ACKNOWLEDGE message 516 discussed with reference to FIG. 5, to the source gNB 101 indicating the handover acceptance status for all or part of the Remote UEs.

In case context information for the Remote UEs served by the Relay UE 110 (e.g. a Remote UE Context Information list) was included in the HANDOVER REQUEST message received at step 904 by the target gNB 102, the method described in procedure 900 may end at step 904.

According to one aspect, in case context information (e.g. a Remote UE Context Information list) was not included in the HANDOVER REQUEST message received at step 903, the target gNB 102 may request to the source gNB 101, in step 905, a UE Context for the Remote UEs which handover was accepted at step 904, by issuing a REMOTE UE CONTEXT INFO REQUEST message 517, as discussed in relation with FIG. 5. The target gNB 102 may then wait for the reception of the requested Remote UE contexts from the source gNB 101, via the REMOTE UE CONTEXT INFO RESPONSE message 518.

According to another aspect, in case context information (e.g. a Remote UE Context Information list) was not included in the HANDOVER REQUEST message received at step 903, the target gNB 102 may receive from the source gNB 101, in step 905, a UE Context for the Remote UEs which handover was accepted at step 904, via a message similar to the REMOTE UE CONTEXT TRANSFER message 415, as discussed in relation with FIG. 4. The target gNB 102 may then confirm the reception of the Remote UE contexts to the source gNB 101, via a message similar to the REMOTE UE CONTEXT TRANSFER ACKNOWLEDGE message 416 discussed in FIG. 4.

By providing context information for the Remote UEs to the target gNB prior to when handover of the Remote UEs is executed (e.g. providing context information as part of managing handover of the Relay UE 110 or when negotiating handover of the Relay UE between the source gNB and target gNB), executing handover of the Remote UEs to the target gNB 102, when the Relay UE 110 is handed over to the target gNB 102, is faster and more efficient.

FIG. 10 shows a schematic representation of an example communication device or station, in accordance with one or more example embodiments of the present disclosure.

The communication device 1000 may be a device such as a micro-computer, a workstation or a light portable device. The communication device 1000 comprises a communication bus 1013 to which there are preferably connected:
a central processing unit 1011, such as a microprocessor, denoted CPU;
memory for storing data and computer programs containing instructions for the operation of the communication device 1000. The computer programs may contain a number of different program elements or sub-routines containing instructions for a variety of operations and for implementing the invention. For example, the program elements include at least one element for managing handover of a relay UE as discussed above. The at least one element when executed by the central processing unit 1011 configure the processing unit (and hence the communication device 1000) to perform the method(s) as described above.

The communication device 1000 may further comprise at least one communication interface 1002 connected to the radio communication network 1003 over which digital data packets or frames or control frames are transmitted, for example a wireless communication network according to the Release 16 for 5G NR. The frames are written from a FIFO sending memory in RAM 1012 to the communication interface 1002 for transmission or are read from the communication interface 1002 for reception and writing into a FIFO receiving memory in RAM 1012 under the control of a software application running in the CPU 1011.

Each of a UE and base station may comprise such a communication device 1000.

The central processing unit 1011 may be a single processing unit or processor or may comprise two or more processing units or processors carrying out the processing required for the operation of the communication device 1000. The number of processing units or processors and the allocation of processing functions to the processing unit(s) is a matter of design choice for a skilled person.

The memory may include:
a read only memory 1007, denoted ROM, for storing computer programs for implementing methods according to embodiments of the invention;
a random-access memory 1012, denoted RAM, for storing the executable code of methods according to embodiments of the invention as well as the registers adapted to record variables and parameters necessary for implementing methods according to embodiments of the invention.

Optionally, the communication device 1000 may also include the following components:
a data storage means 1004 such as a hard disk, for storing computer programs for implementing methods according to one or more embodiments of the invention;
a disk drive 1005 for a disk 1006, the disk drive being adapted to read data from the disk 1006 or to write data onto said disk;
a screen 1009 for displaying decoded data and/or serving as a graphical interface with the user, by means of a keyboard 1010 or any other user input means.

Preferably the communication bus 1013 provides communication and interoperability between the various elements included in the communication device 1000 or connected to it. The representation of the bus 1013 is not limiting and in particular, the central processing unit is operable to communicate instructions to any element of the communication device 1000 directly or by means of another element of the communication device 1000.

The disk 1006 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1007, on the hard disk 1004 or on a removable digital medium such as for example a disk 1006 as described previously. According to an optional variant, the executable code of the programs can be received by means of the communication network 1003, via the communication interface 1002, in order to be stored in one of the storage means of the communication device 1000, such as the hard disk 1004, before being executed.

The central processing unit 1011 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1004 or in the read only memory 1007, are transferred into the random-access memory 1012, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC). In such a case, logic units are configured to perform the steps of the method(s) in accordance with the present invention described above.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for use in managing handover of a relay user equipment, UE, from a source base station to a target base station, the relay UE serving one or more remote UEs via one or more sidelink connections, the method at the source base station comprising:
sending, to the target base station, a handover request for the relay UE;
sending, to the target base station, remote UE information associated with all or some of the one or more remote UEs served by the relay UE,
wherein the remote UE information includes a list of multipath remote UEs information for indicating at least one of the number and identifiers of the one or more remote UEs also directly connected to the source base station.

2. The method of claim 1, wherein sending remote UE information comprises sending remote UE information associated with all or some of the one or more remote UEs served by the relay UE as part of managing handover of the relay UE.

3-4. (canceled)

5. The method of claim 1, further comprising receiving remote UE handover information for indicating which remote UEs of the one or more remote UEs would remain connected to the relay UE after handover of the relay UE is completed.

6. The method of claim 1, further comprising:
receiving, from the relay UE, remote UE handover information relating to the one or more remote UEs;
determining the remote UE information associated with all or some of the one or more remote UEs for sending to the target base station based on the remote UE handover information received from the relay UE.

7. The method of claim 6, further comprising:
sending, to the relay UE, a request for information relating to the one or more remote UEs;
wherein receiving, from the relay UE, remote UE handover information relating to the one or more remote UEs comprises receiving, from the relay UE and in response to the request, remote UE handover information relating to all or some of the one or more remote UEs.

8. The method of claim 1, wherein sending the handover request comprises sending the handover request for the relay UE in a handover request message, wherein the handover request message for the relay UE includes at least one of:
sidelink relay UE handover information for indicating that the UE for which a handover has been requested is a relay UE;
a handover request identifier for uniquely identifying the handover request for the relay UE.

9. The method of claim 1, wherein the remote UE information further includes at least one of:
sidelink remote UE handover information for indicating that the UE for which a handover has been requested is a remote UE;
list of remote UEs information for indicating at least one of the number and the identifiers of the remote UEs which would remain connected to the relay UE after handover for the relay UE is completed;
list of bounded remote UEs information for indicating at least one of the number and the identifiers of the one or more remote UEs having a certain relationship with the relay UE;
remote UE context information including context information for at least one of the all or some of the one or more remote UEs;
remote UE requirement information for indicating communication requirements for at least one of the all or some of the one or more remote UEs.

10. (canceled)

11. The method of claim 1, wherein sending the handover request comprises sending the handover request for the relay UE in a handover request message, wherein sending remote UE information comprises sending remote UE information in the handover request message for the relay UE.

12. The method of claim 11, wherein the remote UE information included in the handover request message for the relay UE includes:
remote UE quantity information for indicating a quantity of resource required at the target base station for the all or some of the one or more remote UEs served by the relay UE, the remote UE quantity information including the list of multipath remote UEs information;
remote UE context information including context information for at least one remote UE of the all or some of the one or more remote UEs.

13. The method of claim 12, wherein the remote UE information in the handover request message for the relay UE includes remote UE requirement information for indicating communication requirements for at least one remote UE of the all or some of the one or more remote UEs.

14. The method of claim 1, wherein sending the handover request comprises sending the handover request for the relay UE in a handover request message, wherein sending remote UE information comprises sending first remote UE information in the handover request message for the relay UE and sending second remote UE information in at least one different message to the handover request message for the relay UE.

15. The method of claim 14,
wherein the first remote UE information included in the handover request message for the relay UE includes remote UE quantity information for indicating a quantity of resource required at the target base station for the all or some of the one or more remote UEs served by the relay UE, the remote UE quantity information including the list of multipath remote UEs information,
wherein the second remote UE information included in a different message to the handover request message for the relay UE includes remote UE context information including context information for at least one remote UE of the all or some of the one or more remote UEs.

16. The method of claim 15, wherein the second remote UE information includes remote UE requirement information for indicating communication requirements for at least one remote UE of the all or some of the one or more remote UEs, the remote UE requirement information being sent with the remote UE context information in the different message or being sent in another different message.

17. The method of claim 1, wherein sending the handover request comprises sending the handover request for the relay UE in a handover request message, wherein sending remote UE information comprises sending remote UE information in at least one different message to the handover request message for the relay UE.

18. The method of claim 17, wherein the at least one different message is at least one handover request message for a remote UE.

19. The method of claim 17, wherein sending remote UE information comprises sending remote UE information in a different message to the handover request message for the relay UE, the remote UE information included in the different message includes at least one of:
remote UE quantity information for indicating a quantity of resource required at the target base station for the all or some of the one or more remote UEs served by the relay UE, the remote UE quantity information including the list of multipath remote UEs information;
remote UE context information including context information for at least one remote UE of the all or some of the one or more remote UEs.

20-21. (canceled)

22. The method of claim 12, wherein the remote UE quantity information further includes at least one of:
list of remote UEs information for indicating at least one of the number and the identifiers of the remote UEs which would remain connected to the relay UE after handover for the relay UE is completed;
list of bounded remote UEs information for indicating at least one of the number and the identifiers of the one or more remote UEs having a certain relationship with the relay UE;
resource load associated with the remote UEs of the one or more remote UEs that would remain connected to the relay UE on completion of handover for the relay UE.

23. (canceled)

24. The method of claim 1, wherein sending the handover request comprises sending the handover request for the relay UE in a handover request message, wherein sending remote UE information comprises sending, for each of the all or some of the one or more remote UEs, a handover request message including remote UE information for the respective remote UE, the remote UE information in each handover request message further includes at least one of:
an identifier for identifying the respective remote UE;
remote UE context information including context information for the respective remote UE;
multipath information for indicating whether the respective remote UE is also directly connected to the source base station;
bounded information for indicating whether the respective remote UE has a certain relationship with the relay UE;
remote UE requirement information for indicating communication requirements for the respective remote UE.

25. The method of claim 1, further comprising receiving handover status information indicating handover granted status for the relay UE and/or all or some of the one or more remote UEs served by the relay UE.

26. The method of claim 15, further comprising receiving handover status information identifying handover granted status for all or some of the one or more remote UEs served by the relay UE, wherein sending the second remote UE information including context information includes sending the second remote UE information based on the handover status information.

27. The method of claim 26, wherein the second remote UE information includes context information only for the remote UEs for which handover is accepted.

28. The method of claim 25, further comprising sending, to the relay UE, remote UE handover status information indicating the remote UEs of the one or more remote UEs that have been accepted by the target base station for handover.

29. (canceled)

30. The method of claim 1, wherein sending, to the target base station, remote UE information associated with all or some of the one or more remote UEs comprises sending the remote UE information in response to a request received from the target base station.

31. The method of claim 30, wherein the request received from the target base station includes at least one of:
related sidelink relay UE handover information for identifying the relay UE serving the remote UEs for which remote UE information is requested by the target base station;
at least one of the number and the identifiers of the remote UEs for which UE context is requested by the target base station.

32. A method for use in managing handover of a relay user equipment, UE, from a source base station to a target base station, the relay UE serving one or more remote UEs via one or more sidelink connections, the method at the target base station comprising:
receiving, from the source base station, a handover request for the relay UE;
receiving, from the source base station, remote UE information associated with all or some of the one or more remote UEs served by the relay UE,
wherein the remote UE information includes a list of multipath remote UEs information for indicating at least one of the number and identifiers of the one or more remote UEs also directly connected to the source base station.

33. The method of claim 32, wherein receiving remote UE information comprises receiving remote UE information associated with all or some of the one or more remote UEs served by the relay UE as part of managing handover of the relay UE.

34. The method of claim 32, further comprising:
determining whether handover of the relay UE can be accepted based on the handover request for the relay UE and/or whether handover of the all or some of the one or more remote UEs can be accepted based on the received remote UE information.

35. The method of claim 32, wherein receiving the handover request comprises receiving the handover request for the relay UE in a handover request message, wherein the handover request message for the relay UE includes at least one of:
sidelink relay UE handover information for indicating that the UE for which a handover has been requested is a relay UE;
a handover request identifier for uniquely identifying the handover request for the relay UE.

36. The method of claim 32, wherein the remote UE information further includes at least one of:
sidelink remote UE handover information for indicating that the UE for which a handover has been requested is a remote UE;
list of remote UEs information for indicating at least one of the number and the identifiers of the remote UEs which would remain connected to the relay UE after handover for the relay UE is completed;
list of bounded remote UEs information for indicating at least one of the number and the identifiers of the one or more remote UEs having a certain relationship with the relay UE;
remote UE context information including context information for at least one of the all or some of the one or more remote UEs;
remote UE requirement information for indicating communication requirements for at least one of the all or some of the one or more remote UEs.

37. (canceled)

38. The method of claim 32, wherein receiving the handover request comprises receiving the handover request for the relay UE in a handover request message, wherein receiving remote UE information comprises receiving remote UE information in the handover request message for the relay UE.

39. The method of claim 38, wherein the remote UE information included in the handover request message for the relay UE includes:
remote UE quantity information for indicating a quantity of resource required at the target base station for the all or some of the one or more remote UEs served by the relay UE, the remote UE quantity information including the list of multipath remote UEs information;
remote UE context information including context information for at least one remote UE of the all or some of the one or more remote UEs.

40. The method of claim 32, wherein receiving the handover request comprises receiving the handover request for the relay UE in a handover request message, wherein receiving remote UE information comprises receiving first remote UE information in the handover request message for the relay UE and receiving second remote UE information in at least one different message to the handover request message for the relay UE.

41. The method of claim 40,
wherein the first remote UE information included in the handover request message for the relay UE includes remote UE quantity information for indicating a quantity of resource required at the target base station for the all or some of the one or more remote UEs served by the relay UE, the remote UE quantity information including the list of multipath remote UEs information,
wherein the second remote UE information included in a different message to the handover request message for the relay UE includes remote UE context information including context information for at least one remote UE of the all or some of the one or more remote UEs.

42. The method of claim 32, wherein receiving the handover request comprises receiving the handover request for the relay UE in a handover request message, wherein receiving remote UE information comprises receiving remote UE information in at least one different message to the handover request message for the relay UE.

43. The method of claim 42, wherein receiving remote UE information comprises receiving remote UE information in a different message to the handover request message for the relay UE, the remote UE information included in the different message includes:
remote UE quantity information for indicating a quantity of resource required at the target base station for the all or some of the one or more remote UEs served by the relay UE, the remote UE quantity information including the list of multipath remote UEs information;
remote UE context information including context information for at least one remote UE of the all or some of the one or more remote UEs.

44-45. (canceled)

46. The method of claim 39, wherein the remote UE quantity information further includes at least one of:
list of remote UEs information for indicating at least one of the number and the identifiers of the remote UEs which would remain connected to the relay UE after handover for the relay UE is completed;
list of bounded remote UEs information for indicating at least one of the number and the identifiers of the one or more remote UEs having a certain relationship with the relay UE;
resource load associated with the remote UEs of the one or more remote UEs that would remain connected to the relay UE on completion of handover for the relay UE.

47. The method of claim 32, wherein receiving the handover request comprises receiving the handover request for the relay UE in a handover request message, wherein receiving remote UE information comprises receiving, for each of the all or some of the one or more remote UEs, a handover request message including remote UE information for the respective remote UE, the remote UE information in each handover request message further includes at least one of:
an identifier for identifying the respective remote UE;
remote UE context information including context information for the respective remote UE;
multipath information for indicating whether the respective remote UE is also directly connected to the source base station;
bounded information for indicating whether the respective remote UE has a certain relationship with the relay UE;
remote UE requirement information for indicating communication requirements for the respective remote UE.

48. The method of claim 32, further comprising:
sending, to the source base station, handover status information indicating handover granted status for the relay UE and/or all or some of the one or more of the remote UEs served by the relay UE.

49. The method of claim 32, further comprising:
sending, to the source base station, a request for remote UE information associated with at least one of the all or some of the one or more remote UEs.

50. The method of claim 49, wherein the request sent to the source base station includes at least one of:
related sidelink relay UE handover information for identifying the relay UE serving the remote UEs for which remote UE information is requested by the target base station;
at least one of the number and the identifiers of the remote UEs for which UE context is requested by the target base station.

51-55. (canceled)

56. The method of claim 1, wherein the handover is a conditional handover, CHO.

57. An apparatus for a source base station for use in managing handover of a relay user equipment, UE, from the source base station to a target base station, the relay UE serving one or more remote UEs via one or more sidelink connections, the apparatus comprising:
one or more processing units configured to:
send, to the target base station, a handover request for the relay UE;
send, to the target base station, remote UE information associated with all or some of the one or more remote UEs served by the relay UE,
wherein the remote UE information includes a list of multipath remote UEs information for indicating at least one of the number and the identifiers of the one or more remote UEs also directly connected to the source base station.

58. An apparatus for a target base station for use in managing handover of a relay user equipment, UE, from the source base station to a target base station, the relay UE serving one or more remote UEs via one or more sidelink connections, the apparatus comprising:
one or more processing units configured to:
receive, from the source base station, a handover request for the relay UE;
receive, from the source base station, remote UE information associated with all or some of the one or more remote UEs served by the relay UE,
wherein the remote UE information includes a list of multipath remote UEs information for indicating at least one of the number and the identifiers of the one or more remote UEs also directly connected to the source base station.

59-60. (canceled)

61. A non-transitory computer-readable storage medium carrying a computer program comprising instructions which, when the program is executed by one or more processing units of a source base station, cause the one or more processing units to:
send, to a target base station, a handover request for handover of a relay user equipment, UE, from the source base station to the target base station;
send, to the target base station, remote UE information associated with all or some of one or more remote UEs served by the relay UE,
wherein the remote UE information includes a list of multipath remote UEs information for indicating at least one of the number and the identifiers of the one or more remote UEs also directly connected to the source base station.

62. The method of claim 32, wherein the handover is a conditional handover, CHO.
